(19) United States
(12) Patent Application Publication
(10) Pub. No.: US 2011/0243079 A1
(43) Pub. Date: Oct. 6, 2011

(54) Transmission Modes and Signaling for Uplink MIMO Support or Single TB Dual-Layer Transmission in LTE Uplink

(75) Inventors: Runhua Chen, Dallas, TX (US); Anthony Ekpenyong, Farmers Branch, TX (US); Eko N. Onggosanusi, Allen, TX (US)

(73) Assignee: TEXAS INSTRUMENTS INCORPORATED, Dallas, TX (US)

(21) Appl. No.: 13/051,680

(22) Filed: Mar. 18, 2011

Related U.S. Application Data
(60) Provisional application No. 61/315,301, filed on Mar. 18, 2010.
(60) Provisional application No. 61/318,847, filed on Mar. 30, 2010.
(60) Provisional application No. 61/330,638, filed on May 3, 2010.
(60) Provisional application No. 61/330,544, filed on May 3, 2010.
(60) Provisional application No. 61/332,500, filed on May 7, 2010.
(60) Provisional application No. 61/332,507, filed on May 7, 2010.
(60) Provisional application No. 61/409,174, filed on Nov. 2, 2010.
(60) Provisional application No. 61/432,273, filed on Jan. 13, 2011.
(60) Provisional application No. 61/433,782, filed on Jan. 18, 2011.

(51) Int. Cl. H04W 72/04

(52) U.S. Cl. 370/329

(57) ABSTRACT

This invention is a method of wireless telephony. A bases station configures a user equipment for single-antenna port or multi-antenna port operation via Radio Resource Control (RRC) signaling including a 5-bit MCS-RV and 1-bit NDI for the second codeword (CW1) are needed for the DCI format 4.

### CLAIM OF PRIORITY

This application claims priority under 35 U.S.C. 119(e)(1) to U.S. Provisional Application No. 61/315,301 filed Mar. 18, 2010, U.S. Provisional Application No. 61/318,847 filed Mar. 30, 2010, U.S. Provisional Application No. 61/330,638 filed May 2, 2010, U.S. Provisional Application No. 61/330,544 filed May 3, 2010, U.S. Provisional Application No. 61/332,500 filed May 7, 2010 U.S. Provisional Application No. 61/332,507 filed May 7, 2010, U.S. Provisional Application No. 61/409,174 filed Nov. 2, 2010, U.S. Provisional Application No. 61/432,273 filed Jan. 13, 2011, and U.S. Provisional Application No. 61/433,782 filed Jan. 18, 2011.

### TECHNICAL FIELD OF THE INVENTION

The technical field of this invention is wireless communication such as wireless telephony.

### BACKGROUND OF THE INVENTION

Uplink Multiple Input, Multiple Output (MIMO) with multiple transmit antennas at the mobile user equipment (UE) is able to increase the channel capacity and link reliability by transmitting multiple data streams simultaneously in the uplink. As a result, uplink MIMO with codebook-based precoding supporting spatial multiplexing of multiple data layers has been adopted as an essential part of LTE-Advanced Rel-10. In contrast in LTE Rel-8 only a single antenna transmission thereby single data stream only is possible in the uplink.

An uplink (UL) grant needs to be transmitted from the base station (eNB) to UE to signal the scheduling information comprising of frequency resource assignment (RA), modulation and coding scheme (MCS), new data indicator (NDI), redundancy version (RV), etc. In addition, for UL-MIMO the uplink grant also needs to include precoding related information such as the transmit rank indicator (TRI) and transmit precoding matrix indicator (TPMI), which may be jointly or separately coded.

### SUMMARY OF THE INVENTION

This invention is a method of wireless telephony. A bases station configures a user equipment for single-antenna port or multi-antenna port operation via Radio Resource Control (RRC) signaling including a 5-bit MCS-RV and 1-bit NDI for the second codeword (CW1) are needed for the DCI format 4.

The base station employs a precoding information field represents joint encoding of transmit rank indicator (TRI) and transmit precoding matrix indicator (TPMI). The joint encoding of TRI and TPMI has 3 bits for two transmitter ports and 6 bits for four transmitter ports and further includes 1-bit TB-to-CW swap flag.

This signaling may use one or two transport blocks (TBs). Transport blocks are selectively enabled or disabled. A TB is enabled or disable when a TRI is 1 via a state of a TB-to-CW swap flag. TBs cannot be enabled or disabled when a TRI is greater than 1.

### BRIEF DESCRIPTION OF THE DRAWINGS

These and other aspects of this invention are illustrated in the drawings, in which:

FIG. 1 illustrates an exemplary prior art wireless communication system to which this application is applicable;

FIG. 2 shows the Evolved Universal Terrestrial Radio Access (E-UTRA) Time Division Duplex (TDD) frame structure of the prior art;

FIGS. 3a and 3b illustrate the indexing for the 4 pairs antennas, FIG. 3a illustrates 4 pairs of Uniform linear array and FIG. 3b illustrates 4 pairs of cross-polarized antennas; and

FIG. 4 is a block diagram illustrating internal details of a base station and a mobile user equipment in the network system of FIG. 1 suitable for implementing this invention.

### DETAILED DESCRIPTION OF PREFERRED EMBODIMENTS

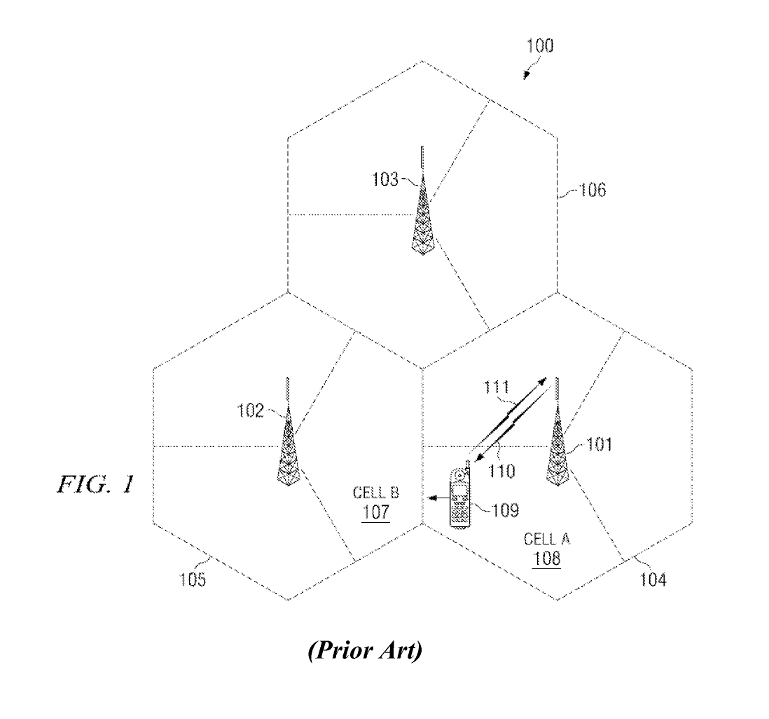

FIG. 1 shows an exemplary wireless telecommunications network 100. The illustrative telecommunications network includes base stations 101, 102 and 103, though in operation, a telecommunications network necessarily includes many more base stations. Each of base stations 101, 102 and 103 (eNB) are operable over corresponding coverage areas 104, 105 and 106. Each base station's coverage area is further divided into cells. In the illustrated network, each base station's coverage area is divided into three cells. Handset or other user equipment (UE) 109 is shown in Cell A 108. Cell A 108 is within coverage area 104 of base station 101. Base station 101 transmits to and receives transmissions from UE 109. As UE 109 moves out of Cell A 108 and into Cell B 107, UE 109 may be handed over to base station 102. Because UE 109 is synchronized with base station 101, UE 109 can employ non-synchronized random access to initiate handover to base station 102.

Non-synchronized UE 109 also employs non-synchronous random access to request allocation of up-link 111 time or frequency or code resources. If UE 109 has data ready for transmission, which may be traffic data, measurements report, tracking area update, UE 109 can transmit a random access signal on up-link 111. The random access signal notifies base station 101 that UE 109 requires up-link resources to transmit the UEs data. Base station 101 responds by transmitting to UE 109 via down-link 110, a message containing the parameters of the resources allocated for UE 109 up-link transmission along with a possible timing error correction. After receiving the resource allocation and a possible timing advance message transmitted on down-link 110 by base station 101, UE 109 optionally adjusts its transmit timing and transmits the data on up-link 111 employing the allotted resources during the prescribed time interval.

Base station 101 configures UE 109 for periodic uplink sounding reference signal (SRS) transmission. Base station 101 estimates uplink channel quality information (CSI) from the SRS transmission.

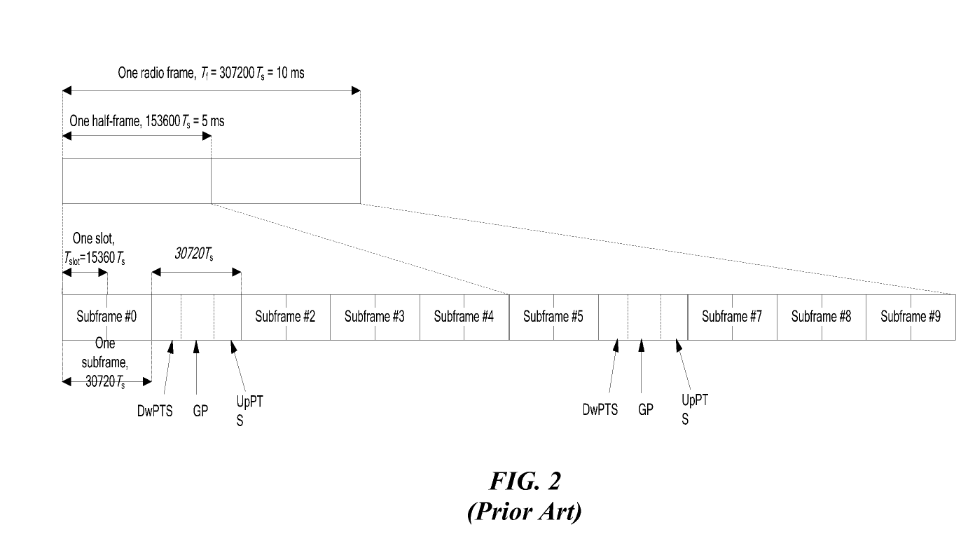

FIG. 2 shows the Evolved Universal Terrestrial Radio Access (E-UTRA) time division duplex (TDD) Frame Structure. Different subframes are allocated for downlink (DL) or uplink (UL) transmissions. Table 1 shows applicable DL/UL subframe allocations.

TABLE 1

| | Switch-point | Sub-frame number | | | | | | | | | |
|---|---|---|---|---|---|---|---|---|---|---|---|
| Configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 10 ms | D | S | U | U | U | D | S | U | U | D |

Uplink Multiple Input, Multiple Output (MIMO) with multiple transmit antennas at the mobile user equipment (UE) is able to increase the channel capacity and link reliability by transmitting multiple data streams simultaneously in the uplink. As a result, uplink MIMO with codebook-based precoding supporting spatial multiplexing of multiple data layers has been adopted as an essential part of LTE-Advanced Rel-10. In contrast in LTE Rel-8 only a single antenna transmission thereby single data stream only is possible in the uplink.

An uplink (UL) grant needs to be transmitted from the base station (eNB) to UE to signal the scheduling information comprising of frequency resource assignment (RA), modulation and coding scheme (MCS), new data indicator (NDI), redundancy version (RV), etc. In addition, for UL-MIMO the uplink grant also needs to include precoding related information such as the transmit rank indicator (TRI) and transmit precoding matrix indicator (TPMI), which may be jointly or separately coded.

This application considers uplink grant design for UL-MIMO in LTE-Advanced.

### Precoding Field

Because the numbers of precoding matrices are different across different rank codebooks, joint encoding of TRI and TPMI should be used to reduce the UL grant size. This results in a 3-bit field two transmitting antennas MIMO and 6-bit TRI/TPMI field for 4 transmitting antennas MIMO. In addition, because the codebook size including the total number of precoders across all ranks is smaller than 8 for 2 transmitting antennas and 64 for 4 transmitting antenna in LTE Rel-10, it is possible to use the reserved TPMI for other scheduling information such as SRS triggering to further reduce the uplink grant size.

### MCS

The LTE-Advanced Rel-10 standard includes separate MCS for two transport blocks (TBs). The baseline option has independent MCS for two TBs with a total of 10-bits overhead. One can have a 5-bit MCS for the first TB and a delta MCS field of 3 or 4 bits for the second TB. This is possible regardless of HARQ bundling.

### NDI

The LTE-Advanced Rel-10 standard includes no layer shifting in uplink. The HARQ bundling is still under discussion. The number of NDI bits (1 or 2) is pending the HARQ bundling decision. In case there is no HARQ bundling, 2 NDI bits are needed for two TBs. Otherwise 1-bit NDI bit may used for both TBs similar to Rel-8.

### Transport-to-codeword Swapping Flag

The LTE-Advanced Rel-10 standard includes a TB to codeword (CW) swapping flag as in Rel-8. This increases the precoding flexibility by allowing the eNB to configure different precoding vectors on different TBs. For example, the first column of rank-2 TPMI can be used on TB1 and the second column of rank-2 TPMI is used on TB2, or vice versa using the TB-to-CW swap bit.

### RV

The LTE-Advanced Rel-10 standard should reuse the mechanism of joint MCS and RV signaling in Rel-8. Thus MCS 0 to 28 are used for RV=0, while MCS 29 to 31 are reserved for RV 1-3. If HARQ bundling is supported, having the same NDI and RV across both TBs is a natural choice.

If no HARQ bundling is adopted (with 2 NDI bits), independently configuring the RV of two TBs to increase the scheduling and link adaptation flexibility is desirable.

If two independent MCS fields are used, RV for two TBs can be separately configured in the LTE-Advanced Rel-10 standard includes re-using the Rel-8 mechanism. Another option adds 2-bit RV fields explicitly for each TB. This is less desirable due to the overhead increase.

If a differential MCS field is adopted, there are five alternatives. Alternative 1 does not support explicit RV signaling. For TB1, RV is implicitly derived from the MCS value (RV=0 for MCS 0 to 28, RV=1 to 3 for MCS 29 to 31). For TB2, RV is implicitly derived from the MCS which is obtained from the differential MCS field. Alternative 2 does not support explicit RV signaling. The RV of the second TB is assumed to be equal to the RV of the first TB, and the MCS of the second TB is derived from the delta MCS value. This reduces the scheduling flexibility since the two TBs must always use the same redundancy version, even if one TB is initial transmission and the other TB is retransmission. Alternative 3 does not support explicit RV signaling. The RV of the second TB is signaled by one of the reserved TPMI field. Alternative 4 has 2-bit explicit RV signaling for the second TB. The first TB re-uses the MCS/RV signaling mechanism in Rel-8. For the second TB, MCS is derived with the difference-MCS with respect to the MCS of the first TB. An example is given in Tables 2 and 3 below. Table 2 notes the coding for a 4-bit differential MCS. Table 3 notes the coding for a 3-bit differential MCS.

TABLE 2

| Differential | |
|---|---|
| MCS Indices | Interpretation |
| 0-14 | Both TBs are enabled. Primary MCS for TB1, |
| | Differential_MCS for TB2 with MCS values |
| | relative to Primary MCS, e.g., [−7, −6, −5, |
| | . . . , 0, . . . , 5, 6, 7] |
| 15 | Reserved or SRS trigger |

TABLE 3

| Differential | |
|---|---|
| MCS Indices | Interpretation |
| 0-16 | Both TBs are enabled. Primary MCS for TB1, |
| | Differential_MCS for TB2 with MCS values |
| | relative to Primary MCS, e.g., [−3, −2, |
| | . . . , 0, . . . , 2, 3] |
| 7 | Reserved or SRS trigger |

Alternative 4 has 2-bit explicit RV signaling similar to Rel-8 downlink for each TB. MCS 29 to 31 could be reserved for other purposes.

### TB Enabling/disabling

In Rel-8 downlink, a TB can be disabled by MCS=0 and RV=1. For the LTE-Advanced Rel-10 standard uplink unless explicit RV signaling is adopted, a different mechanism is needed to signal TB enabling/disabling. There are several alternatives. Alternative 1 adds 2-bit explicit RV in Rel-10 for each TB. This reuses the TB enabling/disabling mechanism of Rel-8 where MCS=0 and RV=1 signals TB disabling. However, this is undesirable due to the increased UL grant size. Alternative 2 has 2-bit explicit RV signaling for the second TB. For TB1 RV is implicitly derived from the first MCS field. For TB2 the 2-bit RV, reuses the TB disabling mechanism of Rel-8 where MCS=0 and RV=1. Thus only TB2 can be disabled. TB1 is always enabled. This is possible since the eNB has scheduling freedom and can schedule retransmission as needed. In alternative 3 the enabling/disabling is implicitly signaled by TRI. For TRI=1, one technique always configures the first TB enabled and the second TB disabled. In this case only TB2 can be disabled and TB1 is always enabled. TB-to-CW swap flag is reserved. In s second technique when TRI=1, the 1-bit TB-to-CW swap flag signals which TB is enabled. This is detailed in Table 4 below.

TABLE 4

| | | |
|---|---|---|
| TRI = 1 | Swap Flag = 0 | TB1 enabled, TB2 disabled |
| | Swap Flag = 1 | TB1 disabled, TB2 enabled |

| | |
|---|---|
| TRI = 2, 3, 4 | Both TBs enabled |

For TRI>1, a single TB transmission occurs only when the initial transmission is rank is 3 or 4 and one of the TBs fails in the prior transmission. When HARQ bundling is configured, both TBs are either initial transmission or retransmission. This case will never happen and requires no further discussion. If HARQ bundling is not supported there could be multiple solutions. If the UE buffer is not empty and the UE has new data to transmit, the eNB may schedule retransmission of TB1 together with a new transmission in TB2. Thus TB enabling/disabling is not required. This is a common operation case for UL MIMO because rank adaptation for MIMO is usually slow and the transmit ranks across consecutive subframes typically possesses a high correlation. If UE buffer is empty and UE has no new data to transmit, the eNB may schedule retransmission of TB1 and TB2 even if TB2 has been successfully decoded. This reduces the problem to a simple implementation-specific issue because the eNB has all the scheduling freedom and can disregard retransmitted TB2 or use SIC receiver to further improve the MIMO equalization reliability of TB1.

Thus enabling/disabling of TBs can be fully supported with TRI=1 and 1-bit TB-to-CW swap flag, while TB disabling for TRI>1 is not needed.

This application concerns uplink grant design for Rel-10 UL-MIMO operation. A first aspect deals with RV bundling. RVs of different TBs can be linked together and assumed to be the same, or implicitly derived from the two MCS fields. Alternatively, explicit RV fields may be added for one or both TBs to increase the scheduling flexibility. TB enabling/disabling is signaled with TRI=1 and a TB-to-CW swap flag. No TB enabling/disabling is supported for TRI>1. Table 5 notes many process variables.

TABLE 5

| Field | Bit-width | Notes |
|---|---|---|
| Flag UL/DL DCI | FFS | |
| differentiation | | |
| Resource block | FFS | FFS |
| assignment | | |
| Primary MCS and | 5 | Same definition as in DCI format |
| RV | | 0 for TB1 |
| Secondary MCS | 3-5 | Absolute MCS for second TB, or |
| | bits | differential MCS |
| NDI | 1 or 2 | Same as Rel-8, pending on HARQ |
| | | bundling discussion. |
| RV | 0 or 1 | 1-bit RV possible for second TB, |
| | | for scheduling flexibility or |
| | | second TB enabling/disabling |
| Precoding | 3 or 6 | 3 bits for 2 Tx, 6 bits for 4 Tx |
| information | | |
| TPC for the | 2 | Same as Rel-8 |
| first antenna | | |
| TPC for the | 0 or 2 | FFS whether per antenna should be |
| second antenna | | supported |
| Cyclic shift | FFS | |
| for DM RS | | |
| UL index (TDD | 2 | Same as Rel-8 |
| only) | | |
| Aperiodic CQI | 1 | Same as Rel-8 |
| request | | |
| Aperiodic SRS | FFS | FFS, may be jointly coded with |
| request | | precoding field. |

Cells marked FFS are for further study. TPC is Transmitter Power Control.

Table 6 lists the TBS index and redundancy version table for PUSCH in Rel-8 Uplink communication.

TABLE 6

| MCS Index | Modulation | TBS Index | Redundancy |
|---|---|---|---|
| I_{MCS} | Order Q′ₘ | I_{TBS} | Version rv_{ids} |
| 0 | 2 | 0 | 0 |
| 1 | 2 | 1 | 0 |
| 2 | 2 | 2 | 0 |
| 3 | 2 | 3 | 0 |
| 4 | 2 | 4 | 0 |
| 5 | 2 | 5 | 0 |
| 6 | 2 | 6 | 0 |
| 7 | 2 | 7 | 0 |
| 8 | 2 | 8 | 0 |
| 9 | 2 | 9 | 0 |
| 10 | 2 | 10 | 0 |
| 11 | 4 | 10 | 0 |
| 12 | 4 | 11 | 0 |
| 13 | 4 | 12 | 0 |
| 14 | 4 | 13 | 0 |
| 15 | 4 | 14 | 0 |
| 16 | 4 | 15 | 0 |
| 17 | 4 | 16 | 0 |
| 18 | 4 | 17 | 0 |
| 19 | 4 | 18 | 0 |
| 20 | 4 | 19 | 0 |
| 21 | 6 | 19 | 0 |
| 22 | 6 | 20 | 0 |
| 23 | 6 | 21 | 0 |
| 24 | 6 | 22 | 0 |
| 25 | 6 | 23 | 0 |
| 26 | 6 | 24 | 0 |
| 27 | 6 | 25 | 0 |
| 28 | 6 | 26 | 0 |

| | | |
|---|---|---|
| 29 | reserved | 1 |
| 30 | | 2 |
| 31 | | 3 |

A number of recent agreements have been made in UL Single-User Multiple Input, Multiple Output (SU-MIMO) a hot topic. There are two of the open issues to resolve: Transmission mode definition; and Downlink control information (DCI) formats. This application deals with these issues.

In the LTE standard Rel-8/9, PUSCH is transmitted only via a single-antenna port. Thus there is no need for the definition of uplink (UL) transmission mode. The LTE-Advanced standard Rel-10 introduced UL multi-antenna transmission thus at least a second multi-antenna-port mode needs to be defined for PUSCH. Only spatial multiplexing is supported for UL MIMO, thus one multi-antenna port mode is sufficient. It is also possible to define another multi-antenna port mode for a single transport block (TB) or a single-layer transmission analogous to transmission mode (TM) 5 for downlink. This allows a single-layer codebook based precoding transmission. The transmission mode configuration for PUSCH is semi-statically configured via Radio Resource Control (RRC) signaling because this is UE specific. The number of antenna ports used for PUSCH transmission may need to be configured based on the UE capabilities. This is not treated as a part of the transmission mode configuration since UE capabilities are communicated by the UEs to the eNodeB.

Likewise, multi-antenna port transmission can be done for Physical Uplink Control CHannel (PUCCH). Each PUCCH format is associated with a single transmit diversity scheme such as SORTD for PUCCH format 1/1a/1b. The configuration is UE specific and set via RRC signaling. Transmission mode configuration for PUSCH and PUCCH can be defined independently. This has an advantage in balancing the amount of PUCCH resources with the need for better PUCCH coverage regardless of PUSCH transmission mode.

A single-antenna port fallback mode is used for each of the multi-antenna modes. This applies to both PUSCH and PUCCH. This fallback mode is used especially when the UE initially connects to the eNodeB. For PUSCH, the fallback mode can be used in case there is some coverage issue in either PUCCH or PUSCH. A reasonable choice is the uplink transmission schemes defined in Rel-8. For PUSCH, the single-antenna-port transmission with contiguous resource allocation is used as a fallback mode. Some possibilities of switching to the fallback mode are as follows:

Semi-static: This is more applicable for PUCCH. For PUSCH, this is supported via the transmission mode configuration.

Dynamic: The eNodeB schedules an UL transmission based on the fallback mode anytime. This can be done via an explicit indication in the UL grant associated with the multi-antenna-port transmission during downlink. This is viable solution but may require an additional field in the DCI format unless some free hypotheses within the precoding information field can be used. Alternatively, DCI format 0 is always searched in the PDCCH blind decoding. In this case, the fallback mode associated with DCI format 0 can always be used regardless of the transmission mode configuration. This is analogous to using format 1A for downlink.

At least two UE specific RRC configured transmission modes for PUSCH should be provided These are: 1) single antenna port; and 2) multi-antenna port. The number of antenna ports depends on the UE capability. A third mode of multi-antenna single-TB transmission is possible. PUCCH is separately configured with either single-antenna or multi-antenna port transmission mode. Dynamic switching between a configured transmission mode and the fallback mode, the Rel-8 single-port transmission, is achieved via a default support of DCI format 0 in PDCCH blind decoding process.

Due to the different nature of spatial multiplexing in multi-antenna transmission, at least one new DCI format is needed for multi-antenna transmission. Table 7 shows the additional DCI fields needed to support multi-antenna transmission based on DCI format 0 as defined in Rel-8/9. Differences due to UL SU-MIMO are highlighted, assuming contiguous RA.

TABLE 7

| | Format 0 | | Format 4 | | Format 4A | |
|---|---|---|---|---|---|---|
| | (single- | | (multi-antenna | | (multi-antenna | |
| | antenna) | | up to 2 TB) | | 1-layer) | |
| | 5 | 20 | 5 | 20 | 5 | 20 |
| Field | MHz | MHz | MHz | MHz | MHz | MHz |
| Format flag | 1 | 1 | 1 | 1 | 1 | 1 |
| Hopping flag | 1 | 1 | 1 | 1 | 1 | 1 |
| RB assignment: | 9 | 13 | 9 | 13 | 9 | 13 |
| MCS-RV for CW0 | 5 | 5 | 5 | 5 | 5 | 5 |
| New Data | 1 | 1 | 1 | 1 | 1 | 1 |
| Indicator for CW0 | | | | | | |
| MCS-RV for CW0 | — | — | 5 | 5 | — | — |
| New Data | — | — | 1 | 1 | — | — |
| Indicator for CW1 | | | | | | |
| TB-to-CW | — | — | 1 | 1 | — | — |
| swap flag | | | | | | |
| TPC | 2 | 2 | 2 | 2 | 2 | 2 |
| Cyclic shift | 3 | 3 | 3 | 3 | 3 | 3 |
| for DMRS | | | | | | |
| CQI request | 1 | 1 | 1 | 1 | 1 | 1 |
| UL index | 2 | 2 | 2 | 2 | 2 | 2 |
| (TDD only) | | | | | | |
| RNTI/CRC | 16 | 16 | 16 | 16 | 16 | 16 |
| Precoding | — | — | 3 | 3 | 3 | 3 |
| information | | | (2 Tx) | (2 Tx) | (2 Tx) | (2 Tx) |
| (TPMI + TRI) | | | or 6 | or 6 | or 5 | or 5 |
| (2 TX or 4 TX) | | | (4 Tx) | (4 Tx) | (4 Tx) | (4 Tx) |

RNTI means Radio Network Temporary Identifier.

There are two formats supporting multi-antenna spatial multiplexing (format 4) and single-layer precoding (format 4A) shown in Table 7. Format 4A is needed only when a multi-antenna transmission mode with only 1 layer is supported. This is analogous to transmission mode 5 in DL.

In the LTE-Advanced standard Rel-10, this corresponds to contiguous Radio Bearer (RB) allocation and a single component carrier. Some additional fields such as CIF, SRS activation, and potentially larger bit-width for RB assignment may be required.

The following considerations were made:

Based on provision of 2 MCSs, 2 NDIs, and 2 HARQ-ACKs, one additional MCS-RV and one additional NDI associated with the second codeword (CW1) are needed whenever up to 2 TBs can be transmitted. Delta MCS is not used to prevent unnecessary scheduling or link adaptation limitations in the retransmission. A TB-to-CW swap flag is introduced similar to that in used in DCI format 2/2A to allow the possibility of swapping the TB-to-CW mapping. This is useful in disabling one of the TBs (TB1 or TB2) while maintaining CW0 always enabled by default.

The cyclic shift and OCC assignment for the additional Demodulation Reference Signal (DMRS) ports are inferred from the assignment for the first port. There is no need for the additional fields. Per-CW/layer power control is not supported and thus no additional TPC field needed. This invention introduces one precoding information field representing joint encoding of TPMI and TRI. Table 8 shows the codebook designs. Three bits are needed for 2 Tx and 6 bits are needed for 4 Tx when all the possible transmission ranks are supported. For 1-layer transmission, only the rank-1 codebook is relevant. In this case, 3 bits and 5 bits are needed for 2 Tx and 4 Tx, respectively.

TABLE 8

| | |
|---|---|
| | Codebook |
| Rank | Size |

| (number of layers) | 2 TX | 4 TX |
|---|---|---|
| 1 | 6 | 24 |
| 2 | 1 | 16 |
| 3 | — | 12 |
| 4 | — | 1 |

Two issues need to be considered in relation to the design of DCI format 4 for supporting up to 2 TB transmission. The first issue is indication of TB disabling where one of the TBs is disabled such as TBS=0 via MCS-RV field. In Rel-8/9, TBS=0 (disabling) needs to be signaled only in the UL grant when Channel Quality Indicator (CQI) request is activated. This signaling includes no data, only a CQI trigger. The condition is as follows: MCS=29, N_RB≦4, and CQI request=1. A non-zero number of RBs is used for transmitting the QPSK-modulated CQI (UCI). N_RB=0 is not possible with the types of resource allocation currently defined. For Rel-10 this transmission is needed when only 1 TB is transmitted in case of DCI format 4 regardless whether CQI request is present (=1) or not (=0).

The second issue is support of 1-TB-2-layer transmission for 4 Tx. The main intention of layer mapping is to support retransmission, use for a first transmission is not precluded by the specification for DL SU-MIMO. Since the same layer mapping and HARQ principles are adopted for UL SU-MIMO, it is natural to support such layer mapping in UL SU-MIMO. While supporting this functionality is possible by adding a dedicated field in the DCI, a better solution does not increase the DCI payload because this functionality is intended only for retransmission.

These two issues are closely related and need to be considered together. If the 1-TB-2-layer transmission for 4 Tx is not supported, TBS=0 indication for format 4 is not needed for 1-TB transmission since the disabled TB can be inferred from the precoding information field by extracting the TRI value since TRI=1 implies 1 TB and the TB-to-CW swap flag indicating which of the two TBs is mapped onto CW1 and hence disabled. The MCS-RV value for CW1 becomes irrelevant in this case. If the 1-TB-2-layer transmission is supported, this is no longer true since TRI=2 may imply either 1-TB or 2-TB transmission. Restricting the use of 1-TB-2-layer mapping for retransmission only does not simplify this problem.

Disabling a TB is equivalent to disabling CW1 when the TB-to-CW swap flag is used. There are several possible solutions to indicate CW1 disabling for DCI format 4.

(1) Adopt the MCS indication scheme used for DL. TBS disabled is indicated by MCS=0 and RV=1 for CW1. The MCS indication scheme in the DL using separate encoding of MCS and RV and a different MCS table interpretation is used in place of the MCS indication mechanism for Rel-8/9 UL. This means there is no dedicated field for RV since RV is a part of the MCS field. This is not preferred since the MCS indication technique for Rel-8/9 UL was designed based on the assumption of synchronous HARQ among other considerations.

(2) Extend the Rel-8/9 UL mechanism with a slight modification. This uses MCS=29 for CW1 and N_RB≦4 regardless of the CQI request to indicate CW1 disabling. This does not allow the eNB to schedule an adaptive retransmission with RV=1 and smaller RB allocation even when CQI request is not present (=0). This does not significantly impact scheduling flexibility for larger UL system bandwidth, it significantly constrains smaller UL system bandwidths such as 1.4 MHz where only 6 RBs are available with contiguous resource allocation. An alternative of this technique uses MCS=29 for CW1 with a smaller N_RB value such as N_RB=1. This imposes less constraint upon scheduling flexibility for smaller system bandwidth and no constraint to larger system bandwidths with Radio Bearer Group (RBG) level allocation which is potentially used for non-contiguous RB allocation). This alternative seems preferred compared to the first alternative.

Using a solution to the TB disabling problem makes the problem of supporting 1-TB-2-layer transmission simpler. A UE may assume an assignment/grant with 1-TB-2-layer mapping when CW1 is disabled for example MCS=29 for CW1 and N_RB=1. The TB associated with CW1 is indicated via the TB-to-CW swap flag. A TB-to-CW swap flag of 0 indicates the first TB is mapped to CW0 and the second TB mapped to the disabled CW1 and vice versa. In this case TRI=2 is extracted from the precoding information field. Any of the 16 rank-2 precoding matrices can be used.

If the constraint in scheduling flexibility associated with TB disabling is to be avoided, supporting the 1-TB-2-layer mapping is still possible without using a TB disabling mechanism. One solution uses the reserved hypotheses in the precoding information field. Since the total number of hypotheses for 4 Tx precoding is 24+16+12+1=53, there are 11 unused hypotheses from the 6-bit precoding information field. The 11 unused hypotheses can then be used to support 1-TB-2-layer mapping in addition to the 16 hypotheses used for 2-TB-2-layer mapping. Those 11 hypotheses will indicate TRI=2 with 1 TB with the use of a subset of the size-16 rank-2 codebook. Using fewer than 11 hypotheses such as 8 is also possible if 8 precoding matrices are deemed sufficient. This does not impose any scheduling restriction on the number of RBs, it does not allow the use of all the 16 available rank-2 precoding matrices. This restriction may however be acceptable since the use of 1-TB-2-layer mapping is believed to be less common than 2-TB-2-layer mapping for 4 Tx.

(3) Utilize the unused MCS-RV and NDI fields of the disabled TB jointly with precoding information field (PIF) to signal precoding information (TPMI+TRI) in conjunction with the number of TBs whenever applicable. Additional bits are jointly encoded with the unused MCS-RV+RI thereby circumventing the need for an explicit TB disabling mechanism. The total payload is reduced by 2 bits for 2 Tx and 1 bit for 4 Tx. This scheme also utilizes NDI, it does not utilize NDI toggling as in the second alternative. Thus this scheme is not susceptible to a missed detection of the previous UL grant.

Among these alternatives the third alternative seems to be promising although it departs from the TB-specific definition. One minor modification adds some more hypotheses into the precoding information field (PIF) as shown in Table 9 for 2 Tx and Table 10 for 4 Tx. This is a variation upon the third alternative.

Table 9 for 2 Tx requires a total of 3 PIF hypotheses (2 bits).

TABLE 9

| | | Interpretation | | | |
|---|---|---|---|---|---|
| PIF | MCS-RV and NDI of | Disabled | | Number | |
| hypothesis | disabled TB | TB | TRI | of TBs | TPMI |
| 0 | Hypothesis 0 to 5 | TB1 | 1 | 1 | 0-5 |
| | of MCS-RV, NDI | | | | |
| | unused | | | | |
| 1 | Hypothesis 0 to 5 | TB2 | 1 | 1 | 0-5 |
| | of MCS-RV, NDI | | | | |
| | unused | | | | |
| 2 | Disregard | none | 2 | 2 | 0 |

Table 10 for 4 Tx requires a total of PIF 31 hypotheses (5 bits).

TABLE 10

| | | Interpretation | | | |
|---|---|---|---|---|---|
| PIF | MCS-RV and NDI of | Disabled | | Number | |
| hypothesis | disabled TB | TB | TRI | of TBs | TPMI |
| 0 | Hypothesis 0 to 23 | TB1 | 1 | 1 | 0-23 |
| | of MCS-RV, NDI = 0 | | | | |
| 0 | Hypothesis 0 to 15 | TB1 | 2 | 1 | 0-15 |
| | of MCS-RV, NDI = 1 | | | | |
| 1 | Hypothesis 0 to 23 | TB2 | 1 | 1 | 0-23 |
| | of MCS-RV, NDI = 0 | | | | |
| 1 | Hypothesis 0 to 15 | TB2 | 2 | 1 | 0-15 |
| | of MCS-RV, NDI = 1 | | | | |
| 2-17 | Disregard | none | 2 | 2 | 0-15 |
| 18-29 | Disregard | none | 3 | 2 | 0-11 |
| 30 | Disregard | none | 4 | 2 | 0 |

Apart from the overhead saving from the most simplistic scheme, this variation of the third alternate does not suffer from the previous UL grant dependency as in the second alternative. This variation of the third alternative still uses the TB-specific MCS-RV/NDI definition. This only costs 1 additional bit for 2 Tx and none for 4 Tx.

The CQI request procedure may need to be slightly extended for DCI format 4 regardless of the solution for TB disabling and/or supporting 1-TB-2-layer mapping. In the presence of a UL data request in the UL grant, the CQI request procedure is simply sets CQI request to 1. In the absence of data, setting both “MCS-RV for CW0” and “MCS-RV for CW1” to 29 should be sufficient to indicate CQI request without data in addition to setting CQI request to 1 and N_RB≦4. Setting N_RB≦4 implies QPSK modulation. While it is also possible to use TRI from the precoding information field to indicate CQI request in conjunction to the other hypotheses, this is only applicable when UCI is always reported as a rank-1 transmission. This is only one of several alternatives for UCI multiplexing solution. This may also be applicable to SRS activation.

A 5-bit MCS-RV and 1-bit NDI for the second codeword CW1 are needed for the DCI format 4 supporting multi-antenna spatial multiplexing transmission mode. The precoding information field represents joint encoding of TRI and TPMI requires 3 bits for 2 Tx and 6 bits for 4 Tx. This further needs a 1-bit TB-to-CW swap flag.

There are two alternative to consider for support for 1-TB-2-layer mapping for 4 Tx. The first alternative adds a CW1 disabling mechanism indicated by for example MCS for CW1=29 and N_RB=1 scheduling restrictions. The second alternative uses all or some out of the 11 unused hypotheses in precoding information field to indicate rank-2 precoding restriction when 1-TB-2-layer transmission occurs.

This invention sets transmission mode configuration and DCI format to support UL multi-antenna transmission as follows. This invention has at least two UE-specific RRC-configured transmission modes for PUSCH: 1) single-antenna port; 2) multi-antenna port where the number of antenna ports depends on the UE capability. A third mode of multi-antenna single-TB transmission is possible. PUCCH is separately configured with either single-antenna or multi-antenna port transmission mode. Dynamic switching between the configured transmission mode and the fallback mode corresponding to the Rel-8 single-port transmission is achieved via default support of DCI format 0 in PDCCH blind decoding process. A 5-bit MCS-RV and 1-bit NDI for the second codeword (CW1) used in DCI format 4 supports multi-antenna spatial multiplexing transmission mode. A precoding information field represents joint encoding of TRI and TPMI having 3 bits for 2 Tx and 6 bits for 4 Tx. This coding includes a 1-bit TB-to-CW swap flag. This invention supports 1-TB-2-layer mapping for 4 Tx.

There are two alternatives DCI format 4 with only one selected. The first alternative adds a CW1 disabling mechanism indicated by for example MCS for CW1=29 and N_RB=1 scheduling restrictions. The second alternative uses all or some out of the 11 unused hypotheses in precoding information field to indicate rank-2 precoding restriction when 1-TB-2-layer transmission occurs. In the absence of data, a CQI request is indicated by CQI request=1, MCS-RV for CW0 and MCS-RV for CW1 both equal 29 and N_RB≦4.

This invention supports UL SU-MIMO using some additional fields over DCI format 0 in the DCI format 4. Table 11 shows the additional DCI fields needed to support multi-antenna transmission based on DCI format 0 as defined in Rel-8/9.

TABLE 11

| | Format 0 | | Format 4 | |
|---|---|---|---|---|
| | (single | | (multi-antenna | |
| | antenna) | | up to 2 TB) | |
| Field | 5 MHz | 20 MHz | 5 MHz | 20 MHz |
| Format Flag | 1 | 1 | — | — |
| Hipping Flag | 1 | 1 | — | — |
| RB assignment: | 9 | 13 | 9 | 13 |
| MCS-RV for TB1 | 5 | 5 | 5 | 5 |
| New Data Indicator | 1 | 1 | 1 | 1 |
| for TB1 | | | | |
| MSC-RV for TB2 | — | — | 5 | 5 |
| New Data Indicator | — | — | 1 | 1 |
| for TB2 | | | | |
| TPC | 2 | 2 | 2 | 2 |
| Cyclic shift for | 3 | 3 | 3 | 3 |
| DMRS | | | | |
| CQI request | 1 | 1 | 1 | 1 |
| UL index (TDD only) | 2 | 2 | 2 | 2 |
| RNTI/CRC | 16 | 16 | 16 | 16 |
| Predecoding | — | — | Up to 3 | Up to 3 |
| information field | | | (2 Tx) or | (2 Tx) or |
| PIF (including | | | Up to 6 | Up to 6 |
| TPMT + TRI) (2 Tx or | | | (4 Tx) | (4 Tx) |
| 4 Tx) | | | | |

This configuration represents contiguous RB allocation and a single component carrier. Some additional fields such as CIF, SRS activation, extended CQI request field for multiple DL component carriers and potentially larger bit-width for RB assignment may be needed.

Table 12 notes the precoding codebook size for UL SU-MIMO.

TABLE 12

| | |
|---|---|
| Rank | Codebook Size |

| (number of layers) | 2 TX | 4 TX |
|---|---|---|
| 1 | 6 | 24 |
| 2 | 1 | 16 |
| 3 | — | 12 |
| 4 | — | 1 |
| Total Number of | 7 | 53 |
| hypothesis | | |

Based on selection of 2 MCSs, 2 NDIs, and 2 HARQ-ACKs, one additional MCS-RV and one additional NDI associated with the second transport block (TB2) are needed whenever up to 2 TBs can be transmitted. Delta MCS is not used to prevent some unnecessary scheduling or link adaptation limitation in the retransmission. CW0 is always enabled by default [8] in the same manner as Rel-8 to allow simpler specification for layer mapping. Mapping from TB to CW is fixed for 2 TB transmission. MCS-RV and NDI are defined as TB-specific in the same was as Rel-8 DL SU-MIMO. While TB-to-CW swap flag is used for Rel-8/9 DL SU-MIMO to allow some flexibility in mapping TB to CW, its utility for UL SU-MIMO is unclear. This invention does not introduce such a DCI field. The format flag in DCI format 0 which indicates whether it is format 0 or 1A is not needed for DCI format 4. While PUSCH hopping could be useful for single-antenna transmission especially for contiguous RA, its use with precoded spatial multiplexing in UL SU-MIMO is unclear. Little additional diversity gain is expected. This invention does not support frequency hopping for UL SU-MIMO in DCI format 4. The cyclic shift and OCC assignment for the additional DMRS ports are inferred from the assignment for the first port with no need for additional fields.

This invention introduces one precoding information field (PIF) which includes TPMI and TRI. The most simplistic alternative jointly encodes TPMI and TRI. Based on the agreed codebook designs shown in Table 10, 3 bits are needed for 2 Tx and 6 bits are needed for 4 Tx. A more efficient and robust design is discussed later.

MCS-RV and NDI are TB-specific are implemented similar to Rel-8 DL SU-MIMO. A 5-bit MCS-RV and 1-bit NDI for the second TB (TB2) are needed for DCI format 4 supporting multi-antenna spatial multiplexing transmission mode. This invention supports a 1-TB-2-layer mapping for 4 Tx. This invention introduces a precoding information field (PIF) as follows. The Precoding information field (PIF) has 2 bits for 2 Tx and 5 bits for 4 Tx. TPMI and TRI and the number of TBs if necessary are communicates by the precoding information field (PIF) together with the unused MCS-RV+NDI fields. For 1-TB transmission, PIF indicates which of the two TBs is disabled. Knowing which TB is disabled allows the UE to look at the appropriate unused MCS-RV/NDI fields for TPMI and TRI information. For 2-TB transmission whihch occupy different set of hypotheses from 1-TB transmission, PIF directly communicates the TPMI and TRI information. Tables 11 and 12 show examples of this coding.

This invention has the following advantages. It avoids dependency on the previous UL grant of the second alternative and sticks to a TB-specific definition. Tables 11 and 12 are exemplary only. Different value assignments to the hypotheses are feasible.

In CQI-only triggering, the current LTE-Advanced standard Rel-10 proposes:
If DCI format 0 is used for the UL grant;
   Aperiodic CQI-only PUSCH can be enabled by setting IMCS=29, NPRB<=X and CQI request=1;
      X is FFS, pending the outcome of CQI payload discussion in MIMO and CA;
      Modulation format QPSK is supported;
         Additional support of 16QAM is FFS, pending the outcome of CQI payload discussion in MIMO and CA.
If DCI format 4 is used for the UL grant;
   CQI-only transmission is supported if the transmission rank is 1;
      Aperiodic CQI-only PUSCH can be signaled by setting IMCS enabled TB=29, NPRB<=X and CQI request=1;
         X is FFS, pending the outcome of CQI payload discussion in MIMO and CA;
         Modulation format, QPSK is supported;
         Additional support of 16QAM is FFS, pending the outcome of CQI payload discussion in MIMO and CA.
            The current LTE-Advanced standard also includes the following TB disabling mechanism. A TB is disabled if either (I_MCS=0, N_PRB>1) or if (I_MCS=28, N_PRB=1) is signaled.

This application includes remaining details for the DCI format 4 and urges reconsider some of components of the agreement in light of the TB-disabling mechanism.

In the prior standard Rel-8/9, only one transport block (TB) is available for CQI transmission. CQI-only triggering with DCI format 0 is achieved via a combination of I_MCS=29 intended for retransmission and a small number of allocated Physical Resource Block (PRBs) needed just for CQI-only transmission (≦4). This combination results in marginal scheduling restriction because multiplexing retransmitted data and CQI within such a small number of PRBs is not a favorable grant assignment. When more than one DL component carriers (CCs) are assigned in the current LTE-Advanced standard Rel-10, it was expected that reusing maximum of 4 PRBs is insufficient. A larger maximum number X should be considered. Note that aperiodic CQI mode 3-2 was not agreed for Rel-10. Thus the only mechanism to introduce a larger X is carrier aggregation such as triggering aperiodic CQI for multiple DL CCs. Larger values of X result in more severe scheduling restrictions because the likelihood of multiplexing data with CQI increases with larger PRB allocation. While some additional restriction in CQI triggering may be used to avoid introducing larger value(s) of X, it is difficult or impossible to avoid some type of undesirable restriction when DCI format 0 is used for triggering CQI-only transmission.

Such restrictions do not apply to DCI format 4 especially in light of agreement on the TB disabling mechanism. Both mechanisms incur the same type of scheduling restriction by using a combination of I_MCS and N_PRB values. While the additional scheduling restriction may be incremental, introducing any unnecessary scheduling restriction is undesirable because it further complicates scheduling process by adding more invalid decision points in the scheduling pool.

The adopted mechanism for TB disabling results in some unused hypotheses when one of the two TBs is disabled. This is due to inefficient use of the available hypotheses. Some of the unused hypotheses can be utilized for CQI-only triggering when only 1-TB transmission is allowed for CQI-only triggering.

Adding larger value(s) of X is undesirable for DCI format 0. The also applies to DCI format 4. The set of value(s) for X should be separately considered for DCI format 0 and 4 in order to minimize the throughput loss from not being able to multiplex data and CQI together with restriction on aperiodic CQI triggering. This occurs even when only rank-1 is allowed for CQI-only transmission. While it may be difficult to avoid such inefficiency for DCI format 0, an alternative solution should be considered for DCI format 4.

Utilizing 16QAM to reduce the number of PRBs is complementary at best. Adding 16QAM in addition to QPSK is beneficial only when the required coding rate is low for QPSK. This is because 16QAM requires about 4 dB additional SNR over QPSK for the same coding rate not including the additional back-off due to higher cubic metric in power-limited scenarios.

For 2 Tx the rank-1 only agreement is equivalent to the previous agreement to use only 1 TB for CQI multiplexing on PUSCH. For 4 Tx this restriction seems unnecessary since rank-2 (2-layer) transmission is also possible with 1-TB transmission. In this case, the rank-1 only restriction is contradictory to efforts to minimize the number of PRBs used for CQI-only transmission. The additional spectral efficiency from rank-2 transmission should be used for CQI-only transmission whenever possible. Minimizing the number of PRBs for CQI-only transmission should not be treated as an isolated goal. Any reduction upon the number of PRBs is beneficial for the system as a whole since such PRBs can be used to schedule other UL transmissions.

This invention proposes reconsidering the agreement on CQI-only triggering with DCI format 4. From points the arguments above this invention proposes an alternative mechanism instead of (I_MCS=29) AND (N_PRB≦X). This invention uses some unused hypotheses when one of the 2 TBs is disabled. The NDI and/or MCS-RV fields of the disabled TB can be utilized to indicate CQI-only triggering. From the final point of the arguments above this invention relaxes the rank-1 only restriction and allows rank-2 transmission with 1-TB for the case of 4 Tx. The benefit of introducing 16QAM needs to be justified.

According to a first example of this invention CQI-only transmission is triggered with in DCI format 4 when all the following conditions are fulfilled: (1) the CQI request field is 1 when one DL component carrier is configured or is 01, 10 or 11 when more than 1 DL component carriers are configured; (2) one of the two TBs is disabled where either (I_MCS=0, N_PRB>1) or (I_MCS=28, N_PRB=1) is signaled; and NDI of the disabled TB is 1.

This technique is similar to the last point above except for the rank-1 only restriction. This technique requires no restriction on the number of layers since the precoding information field is interpreted based on the number of enabled TBs. When only 1 TB is enabled, the restriction of 1-layer only for 2 antenna ports and 1 or 2-layer only for 4 antenna ports are already imposed.

It is also possible to utilize some of the other unused hypotheses associated with the disabled TB other than the NDI bit. It is possible to utilize the unused MCS-RV field. This invention uses a scheme similar to the mechanism to TB disabling. According to a second example of this invention CQI-only transmission is triggered with in DCI format 4 in the enabled TB when all the following conditions are fulfilled: (1) CQI request field is 1 when one DL component carrier is configured) or is 01, 10, or 11 when more than 1 DL component carriers are configured; (2) Either (I_MCS=x, N_PRB>1) or (I_MCS=y, N_PRB=1) is signaled for one of the two TBs, where x can be any of the following integers {1, 2, 3, . . . , 26, 27, 29, 30, 31}, and y can be any of the following integers {1, 2, 3, . . . , 26, 27, 29, 30, 31} as long as y is not equal to x, for example (x=1, y=27) or (x=2, y=26), and this is similar to the TB disabling condition noted above but it uses different set of I_MCS values; and (3) the associated TB is disabled. Condition (2) is also an indication of TB disabling when used in conjunction with condition (1). When condition (1) and condition (2) are both satisfied CQI-only transmission is triggered in the enabled TB. Condition 1 alone without condition 2 is not interpreted as TB disabling. This technique does not require the use of NDI bit of the disabled TB and involves fewer conditions than the previous technique at the expense of some additional scheduler restriction. This scheme requires no restriction on the number of layers. These conditions hold regardless whether 16QAM is introduced in addition to QPSK.

An a n-bit precoding field in the uplink grant signals both the TRI and TPMI. For example for 2 Tx (2 antenna ports), the total number of precoders across rank-1 and rank-2 is 7b requiring 3-bits to signal the precoding field. For 4 Tx (4 antenna ports), because the total number of precoding vectors across rank 1-4 codebooks are smaller than 64, 6 bits are need to signal the precoding field.

SU-MIMO in LTE supports up to two transport blocks (TBs) simultaneously. Two TBs are mapped to two codewords, where a TB-to-CW swap bit in the UL grant indicates which TB is mapped to which CW. The number of layers for each CW is indicated by the transmission rank indicator (TRI) as set forht below.

TRI=1: 1 TB, 1-layer per CW

TRI=2: 2 TB, 1-layer per CW

TRI=3: 2TB, 1-layer in the first CW, 2-layer in second CW

TRI=4: 2TB, 2-layer in each CW.

In addition, 1 TB transmission with dual-layer is also possible for 4 Tx (4 antenna ports) SU-MIMO. This only happens when the initial transmission is rank-3 or 4 and one TB within 2-layer fails in the initial transmission, hence the failed TB needs to be retransmitted.

In an LTE Rel-8 downlink, MCS, NDI and RV of two TBs are separately signaled in the uplink grant. Thus MCS=0 and RV=1 is used to signal that the TB is disabled.

TRI=1: one TB is disabled, by MCS=0 and RV=1

TRI=2: one TB or two TBs.

If one TB is enabled, the other TB is disabled, there is one TB with two layers. If two TBs are enabled, each TB has one-layer.

The LTE-Advanced standard Rel-10 uplink reuses the joint MCS and RV signaling mechanism in Rel-8 uplink, where MCS 0-28 signifies RV=0 and MCS 29-31 signifies RV=2, 3 or 4. Because MCS and RV are jointly encoded, the mechanism in Rel-8 for signaling TB disabling (MCS=0, RV=1) cannot be used for Rel-10 uplink.

There is thus a question of how LTE-Advanced Rel-10 indicates 1 TB with 2-layer transmission. This is only required for 4 Tx SU-MIMO. If HARQ bundling is configured, both TBs will be initial transmission or retransmission, hence 1-TB with 2-layer transmission is not needed conceptually. The technique details below applies where HARQ bundling is performed.

This section presents several methods for TB enabling/disabling in Rel-10 uplink with support for 1 TB with dual-layer transmission.

### Explicit RV

This technique adds 2-bit explicit RV for each TB. This re-uses the TB enabling/disabling mechanism in Rel-8 (MCS=0, RV=1 for TB disabling). This is undesirable due to the increased UL grant size.

Joint Encoding with Precoding Field

The number of TB for TRI=2, is jointly encoded with the precoding field. When TRI=2, the number of TBs can be one or two. If the number of TBs is two, each TB has one layer. If the number of TBs is one, the single TB has two layers. A set of precoding fields in the DCI format associated with UL SU-MIMO are reserved for signaling a 1 TB 2 layer transmission. If a 1 TB 2 layer transmission is signaled in the DCI format associated with UL SU-MIMO by the reserved precoding field, the 1-bit TB-to-CW mapping flag denotes which TB is enabled and which TB is disabled. Table 13 shows an example coding.

TABLE 13

| TB-CW swap flag | TB1 | TB2 |
|---|---|---|
| 0 | Enabled | Disabled |
| 1 | Disabled | Enabled |

In case one TB is enabled (1-layer or 2-layer), the enabled TB can be transmitted on a fixed codeword such as CW0 or CW 1. This assumes the sizes of different rank codebooks as follows (Table 14).

TABLE 14

| Rank (number of layers) | Codebook size |
|---|---|
| 1 | 24 |
| 2 | 16 |
| 3 | 12 |
| 4 | 1 |

If 1 TB with 2-layer transmission is not supported, the n-bit precoding field for 4 Tx to signal the TRI and TPMI in the uplink grant is as shown in Table 15, where n=6.

TABLE 15

| Bit field | | |
|---|---|---|
| mapped to | | Number of |
| index | Message | TB/CW |
| 0 | 1 layer, TPMI = 0 | 1 |
| 1 | 1 layer, TPMI = 1 | 1 |
| . | . | . |
| . | . | . |
| . | . | . |
| 23 | 1 layer, TPMI = 23 | 1 |
| 24 | 2 layers, TPMI = 0 | 2 |
| . | . | . |
| . | . | . |
| . | . | . |
| 39 | 2 layers, TPMI = 15 | 2 |
| 40 | 3 layers, TPMI = 0 | 2 |
| . | . | . |
| . | . | . |
| . | . | . |
| 51 | 3 layers, TPMI = 11 | 2 |
| 52 | 4 layers, TPMI = 0 | 2 |
| 53-63 | Reserved, or used | reserved |
| | for other | |
| | signalling (e.g. | |
| | SRS transmission) | |

If 1 TB with 2-layer transmission is supported, the n-bit precoding field for 4 Tx to signal the TRI and TPMI in the uplink grant is as shown in Table 16, where n=7. Indices 40-55 signal 1 TB with 2-layer transmission (TRI=2). Indices 24-39 signal 2 TB with 2-layer transmission (TRI=2). Indices 24-39 and 40-55 can be exchanged in Table 16.

TABLE 16

| Bit field | | |
|---|---|---|
| mapped to | | Number of |
| index | Message | TB/CW |
| 0 | 1 layer, TPMI = 0 | 1 |
| 1 | 1 layer, TPMI = 1 | 1 |
| . | . | . |
| . | . | . |
| . | . | . |
| 23 | 1 layer, TPMI = 23 | 1 |
| 24 | 2 layers, TPMI = 0 | 2 |
| . | . | . |
| . | . | . |
| . | . | . |
| 39 | 2 layers, TPMI = 15 | 2 |
| 40 | 2 layers, TPMI = 0 | 1 |
| . | . | . |
| . | . | . |
| . | . | . |
| 55 | 2 layers, TPMI = 15 | 1 |
| 56 | 3 layers, TPMI = 0 | 2 |
| . | . | . |
| . | . | . |
| . | . | . |
| 67 | 3 layers, TPMI = 11 | 2 |
| 68 | 4 layers, TPMI = 0 | 2 |
| 69-127 | Reserved, or used | reserved |
| | for other | |
| | signalling (e.g. | |
| | SRS transmission) | |

Table 17 corresponds to Table 16 with indices 24-39 and 40-55 exchanged.

TABLE 17

| Bit field | | |
|---|---|---|
| mapped to | | Number of |
| index | Message | TB/CW |
| 0 | 1 layer, TPMI = 0 | 1 |
| 1 | 1 layer, TPMI = 1 | 1 |
| . | . | . |
| . | . | . |
| . | . | . |
| 23 | 1 layer, TPMI = 23 | 1 |
| 24 | 2 layers, TPMI = 0 | 2 |
| . | . | . |
| . | . | . |
| . | . | . |
| 39 | 2 layers, TPMI = 15 | 2 |
| 40 | 3 layers, TPMI = 0 | 2 |
| . | . | . |
| . | . | . |
| . | . | . |
| 51 | 3 layers, TPMI = 11 | 2 |
| 52 | 4 layers, TPMI = 0 | 2 |
| 53 | 2 layers, TPMI = 0 | 1 |
| . | . | . |
| . | . | . |
| . | . | . |
| 68 | 2 layers, TPMI = 15 | 1 |
| 69-127 | Reserved, or used | reserved |
| | for other | |
| | signalling (e.g. | |
| | SRS transmission) | |

It is also possible to support 1 TB 2-layer transmission with a subset (Ω) of the size-16 rank-2 codebook. In this case, the number of states for 1 TB 2-layer signaling in Table 18 can be reduced from 16 to maintain the precoding bit-length to be 6. One example shown in Table 18 shows the precoding bit field where 1 TB 2-layer transmission is supported with 8 rank-2 precoding matrices taken out of the 16 possible precoding matrices. The rank-2 codebook subset Ω can be fixed or semi-statically configured by RRC higher layer signaling. With respect to the rank-2 codebook, an example of a fixed selection would be the first 8 matrices in the rank-2 codebook. This corresponds to nₘ=m, m=0 and 1, . . . , 7.

TABLE 18

| Bit field | | |
|---|---|---|
| mapped to | | Number of |
| index | Message | TB/CW |
| 0 | 1 layer, TPMI = 0 | 1 |
| 1 | 1 layer, TPMI = 1 | 1 |
| . | . | . |
| . | . | . |
| . | . | . |
| 23 | 1 layer, TPMI = 23 | 1 |
| 24 | 2 layers, TPMI = 0 | 2 |
| . | . | . |
| . | . | . |
| . | . | . |
| 39 | 2 layers, TPMI = 15 | 2 |
| 40 | 2 layers, TPMI = n₀ | 1 |
| . | . | . |
| . | . | . |
| . | . | . |
| 47 | 2 layers, TPMI = n₇ | 1 |
| 48 | 3 layers, TPMI = 0 | 2 |
| . | . | . |
| . | . | . |
| . | . | . |
| 59 | 3 layers, TPMI = 11 | 2 |
| 60 | 4 layers, TPMI = 0 | 2 |
| 61-63 | Reserved, or used | reserved |
| | for other | |
| | signalling (e.g. | |
| | SRS transmission) | |

Table 19 below is an alternative encoding.

TABLE 19

| Bit field | | |
|---|---|---|
| mapped to | | Number of |
| index | Message | TB/CW |
| 0 | 1 layer, TPMI = 0 | 1 |
| 1 | 1 layer, TPMI = 1 | 1 |
| . | . | . |
| . | . | . |
| . | . | . |
| 23 | 1 layer, TPMI = 23 | 1 |
| 24 | 2 layers, TPMI = 0 | 2 |
| . | . | . |
| . | . | . |
| . | . | . |
| 39 | 2 layers, TPMI = 15 | 2 |
| 40 | 3 layers, TPMI = 0 | 2 |
| . | . | . |
| . | . | . |
| . | . | . |
| 51 | 3 layers, TPMI = 11 | 2 |
| 52 | 4 layers, TPMI = 0 | 2 |
| 53 | 2 layers, TPMI = n₀ | 1 |
| . | . | . |
| . | . | . |
| . | . | . |
| 60 | 2 layers, TPMI = n₇ | 1 |
| 61-63 | Reserved, or used | reserved |
| | for other | |
| | signalling (e.g. | |
| | SRS transmission) | |

In general, any number N (11) can be chosen where N is the number of rank-2 precoding matrices chosen out of 16. The coding table can then be as follows:

TABLE 20

| Bit field | | |
|---|---|---|
| mapped to | | Number of |
| index | Message | TB/CW |
| 0 | 1 layer, TPMI = 0 | 1 |
| 1 | 1 layer, TPMI = 1 | 1 |
| . | . | . |
| . | . | . |
| . | . | . |
| 23 | 1 layer, TPMI = 23 | 1 |
| 24 | 2 layers, TPMI = 0 | 2 |
| . | . | . |
| . | . | . |
| . | . | . |
| 39 | 2 layers, TPMI = 15 | 2 |
| 40 | 2 layers, TPMI = n₀ | 1 |
| . | . | . |
| . | . | . |
| . | . | . |
| 40 + N − 1 | 2 layers, TPMI = n_{N-1} | 1 |
| 40 + N | 3 layers, TPMI = 0 | 2 |
| . | . | . |
| . | . | . |
| . | . | . |
| 40 + N + 11 | 3 layers:, TPMI = 11 | 2 |
| 40 + N + 12 | 4 layers, TPMI = 0 | 2 |
| 40 + N + 13 to 63 | Reserved, or used | reserved |
| (whenever | for other | |
| applicable) | signalling (e.g. | |
| | SRS transmission) | |

### Not Support 1 TB Dual-layer in Rel-10 Uplink

The LTE-Advanced standard Rel-10 does not support 1-TB with 2-layer. One TB transmission is only supported with TRI=1. For TRI=2, 3 or 4 two TBs are always enabled.

For TRI=1, the 1-bit TB-to-CW swap flag signals which TB is enabled as shown in Table 21 below.

TABLE 21

| | | |
|---|---|---|
| TRI = 1 | Swap flag = 0 | TB1 enabled, TB2 disabled |
| | Swap flag = 1 | TB1 disabled, TB2 enabled |

| | |
|---|---|
| TRI = 2, 3, 4 | Both TBs enabled. |

Another technique always configure the first TB enabled and the second TB disabled. Thus only TB2 can be disabled and TB1 is always enabled. The TB-to-CW swap flag is reserved.

For TRI>1 a single TB transmission with occurs only when the initial transmission is rank=3 or 4 and one of the TBs fails in the prior transmission and no HARQ bundling. If the UE buffer is not empty and UE has new data to transmit, eNB may schedule retransmission of TB1 together with a new transmission in TB2. Thus TB enabling/disabling is not required. This is a common operation case in UL MIMO because rank adaptation for MIMO is usually slow and the transmit ranks across consecutive subframes typically possesses a high correlation. If UE buffer is empty and UE has no new data to transmit, the eNB may schedule retransmission of TB1 and TB2 although TB2 has been successfully decoded. This reduces the problem to a simple implementation-specific issue because the eNB has all the scheduling freedom and can disregard a retransmitted TB2 or use SIC receiver to further improve the MIMO equalization reliability of TB1. A 1 TB with 2-layer is not supported in Rel-10. The precoding field in DCI format associated with UL SU-MIMO is shown in Table 22.

TABLE 22

| Bit field | | |
|---|---|---|
| mapped to | | Number of |
| index | Message | TB/CW |
| 0 | 1 layer, | 1 |
| | TPMI = 0 | |
| 1 | 1 layer, | 1 |
| | TPMI = 1 | |
| . | . | . |
| . | . | . |
| . | . | . |
| 23 | 1 layer, | 1 |
| | TPMI = 23 | |
| 24 | 2 layers, | 2 |
| | TPMI = 0 | |
| . | . | . |
| . | . | . |
| . | . | . |
| 39 | 2 layers, | 2 |
| | TPMI = 15 | |
| 40 | 3 layers, | 2 |
| | TPMI = 0 | |
| . | . | . |
| . | . | . |
| . | . | . |
| 51 | 3 layers, | 2 |
| | TPMI = 11 | |
| 52 | 4 layers, | 2 |
| | TPMI = 0 | |
| 53-63 | Reserved, or | reserved |
| | used for | |
| | other | |
| | signalling | |
| | (e.g. SRS | |
| | transmission) | |

Joint Encoding with Precoding Field and MCS Field, when TB-to-CW Swap Flag is Available

This embodiment reserves a single precoding index in the uplink grant associated with SU-MIMO to signal 1-TB 2-layer transmission. The 1-bit TB-to-CW swap flag indicates which TB is enabled/disabled, while MCS of the disabled TB signals the which rank-2 precoding matrix is used. Note that MCS and NDI corresponds to a TB not a CW.

For 2 Tx a 1-bit precoding field in uplink grant indicates TRI. When TRI=1, then one TB is enabled and one TB is disabled. The 1-bit TB-to-CW flag indicates which TB is enabled. For example if TB-to-CW flag=0 then TB1 is enabled, and MCS1 and NDI1 are used for enabled TB. Otherwise, TB2 is enabled, and MCS2 and NDI2 are used for enabled TB. The 5-bit MCS of the disabled TB signals the precoding vector. Thus MCS 0-5 signals precoding vector 0-5, while the remaining 32−6=26 values are reserved. When TRI=2, then both TB are enabled. MCS1 and NDI1 are used for TB1. MCS2 and NDI2 are used for TB2.

For 4 Tx a 5-bit precoding field is used. For PMI=0, use rank-1 and one TB is enabled. The 1-bit TB-to-CW swap flag indicates which CB is enabled. The 5-bit MCS of the disabled TB indicates the precoding vectors. Since there are 24 rank-1 PMI, the remaining 32−24=8 MCS values are reserved. A value PMI>0 indicates that TRI>1. A first embodiment does not support 1 TB 2-layer. In this first embodiment, if PMI is 1-16, use rank-2 and both TB are enabled. MCS1 and NDI1 are used for TB1. MCS2 and NDI2 are used for TB2. For PMI 17-28 use rank-3 and both TB are enabled. MCS1 and NDI1 are used for TB1. MCS2 and NDI2 are used for TB2. If PMI=29, use rank-4 and both TB are enabled. MCS1 and NDI1 are used for TB1. MCS2 and NDI2 are used for TB2. Finally PMI of 30-31 is reserved. A second embodiment supports 1 TB 2-layer. In the second embodiment if PMI=1, use rank-2 with one TB enabled one TB disabled. The TB-to-CW flag indicates which TB is enabled. For example TB-to-CW flag=0 means TB1 is enabled, MCS1 and NDI1 are used for the enabled TB. Otherwise, MCS2 and NDI2 are used for the enabled TB. A 5-bit MCS of the disabled TB signals precoding field. Since there are 16 rank-2 precoding matrixes, the remaining 32−16=16 values are reserved. In this second embodiment if PMI is 2-17, use rank-2 with both TBs enabled. MCS1 and NDI1 are used for TB1. MCS2 and NDI2 are used for TB2. If PMI is 18-29, use rank-3 with both TBs enabled. MCS1 and NDI1 are used for TB1. MCS2 and NDI2 are used for TB2. If PMI=30, use rank-4 with both TBs enabled. MCS1 and NDI1 are used for TB1. MCS2 and NDI2 are used for TB2. PMI=31 is reserved.

Alternate Joint Encoding with Precoding Field and MCS Field, when TB-to-CW Swap Flag is Available

If a 1-bit TB-to-CW swap flag is not available in the uplink grant, the following design is used for 4 Tx. In a first embodiment, for rank-1, two PMI indices are reserved to signal rank-1 1 TB transmission corresponding to TB1 enable/TB2 disable and TB1 disable/TB2 enable, respectively. For rank-2 with a single TB, the enabled TB is fixed as TB1 or TB2). This first embodiment uses a 5-bit precoding field for 4 Tx. If PMI=0, use rank-1 with TB1 enabled and TB2 disabled. MCS2 is used to signal the rank-1 precoding vector. NDI2 can be used as the TB-CW swap flag. If PMI=1, use rank-1 with both TB1 and TB2 disabled. MCS1 is used to signal tht rank-1 precoding vector. NDI1 can be used as TB-CW swap flag. PMI>1 indicates TRI>1. For PMI=2, use rank-2 with TB1 enabled and TB2 disabled. MCS2 signals the precoding field (16 rank-2 precoding vectors). NDI2 can be used as TB-CW swap flag. For PMI of 3-18, use rank-2 with both TBs enabled. MCS1 and NDI1 are used for TB1. MCS2 and NDI2 are used for TB2. For PMI of 19-30, use rank-3 with both TBs enabled. MCS1 and NDI1 are used for TB1. MCS2 and NDI2 are used for TB2. For PMI=31 use rank-4 with both TBs enabled. MCS1 and NDI1 are used for TB1. MCS2 and NDI2 are used for TB2.

In second embodiment, for rank-2, two PMI indices are reserved to signal rank-2 1 TB transmission, corresponding to TB1 enable/TB2 disable and TB1 disable/TB2 enable, respectively. For rank-2 with single TB, the enabled TB is fixed either TB1 or TB2. This second embodiment uses a 5-bit precoding field for 4 Tx. For PMI=0, use rank-1 with TB1 enabled and TB2 disabled. MCS2 is used to signal rank-1 precoding vector. NDI2 can be used as TB-CW swap flag. PMI>0 indicates TRI>1. For PMI=1, use rank-2 with TB1 enabled and TB2 disabled. MCS2 signals the precoding field. NDI2 can be used as TB-CW swap flag. For PMI=2, use rank-2 with TB1 disabled and TB2 enabled. MCS1 signals the precoding field. NDI1 can be used as TB-CW swap flag. For PMI of 3-18, use rank-2 with both TBs enabled. MCS1 and NDI1 are used for TB1. MCS2 and NDI2 are used for TB2. For PMI of 19-30, use rank-3 with both TBs enabled. MCS1 and NDI1 are used for TB1. MCS2 and NDI2 are used for TB2. For PMI=31 use rank-4 with both TBs enabled. MCS1 and NDI1 are used for TB1. MCS2 and NDI2 are used for TB2.

Joint Encoding with Precoding Field and MCS Field, when TB-to-CW Swap Flag is not Available

If the 1-bit TB-to-CW swap flag is not included in the uplink grant, a fixed mapping between TB to CW is applied. The MCS and NDI values are for a TB as well as for a CW. When only one codeword is transmitted, CW0 (TB1) is always enabled, while CW1 (TB2) is always disabled. This embodiment may reserve a single precoding index in the uplink grant associated with SU-MIMO to signal 1 TB 2-layer transmission. If only one TB/CW is enabled, TB1 is always enabled and TB2 is always disabled. The MCS2 signals the which rank-2 precoding matrix is used.

For 2 Tx with a 1-bit precoding field in the uplink grant indicating TRI, if TRI=1 then TB1 is always enabled and TB2 is always disabled. MCS1 and NDI1 are use for the enabled TB. The 5-bit MCS2 signals the precoding vector. If TR=2, the both TBs are enabled. MCS1 and NDI1 are used for TB1. MCS2 and NDI2 are used for TB2.

For 4 Tx with a 5-bit precoding field, if PMI=0, use rank-1 with one TB enabled. TB1 is always enabled and TB2 is always disabled. MCS1 and NDI1 are used for the enabled TB/CW. NDI2 can be used as TB-CW flag. The 5-bit MCS2 indicates the precoding vectors. If PMI>0 then TRI>1. There are two embodiments. In a first embodiment 1 a 1 TB 2-layer is not supported. If PMI is 1-16, use rank-2 with both TBs enabled. MCS1 and NDI1 are used for TB1. MCS2 and NDI2 are used for TB2. If PMI is 17-28, use rank-3 with both TBs enabled. MCS1 and NDI1 are used for TB1. MCS2 and NDI2 are used for TB2. For PMI of 29, use rank-4, both TB enabled. MCS1 and NDI1 are used for TB1. MCS2 and NDI2 are used for TB2. A PMI of 30-31 is reserved. In a second embodiment, 1 TB 2-layer is supported. If PMI=1, use rank-2 with TB1 enabled and TB2 disabled. The 5-bit MCS2 of disabled TB signals precoding field. NDI2 can be used as TB-CW flag. For PMI of 2-17, use rank-2 with both TBs enabled. MCS1 and NDI1 are used for TB1. MCS2 and NDI2 are used for TB2. For PMI of 18-29, use rank-3 with both TBs enabled. MCS1 and NDI1 are used for TB1. MCS2 and NDI2 are used for TB2. For PMI of 30, use rank-4 with both TBs enabled. MCS1 and NDI1 are used for TB1. MCS2 and NDI2 are used for TB2. A PMI of 31 is reserved.

Alternate Joint Encoding with Precoding Field and MCS Field, when TB-to-CW Swap Flag is not Available

If the 1-bit TB-to-CW swap flag is not available, the unused NDI bit of the disabled TB is used as the TB-to-CW swap flag when 1-TB transmission is scheduled for rank-1 or rank-2. The TB-to-CW mapping can be swapped for 1 TB transmission but not for 2 TB transmission. NDI2 indicates which TB is enabled. In this case, MCS and NDI are CW-specific rather than TB-specific. Thus MCS1 and NDI1 are for CW0, and MCS2 and NDI2 are for CW1. This example assumes that an explicit 1-bit TB-to-CW swap flag is not available. However, it is possible to add this 1-bit flag if swapping is desired for 2 TB transmission.

For 2 Tx the 1-bit precoding field in uplink grant indicates TRI. For TRI=1, use rank-1 with 1 TB enabled. MCS1 and NDI1 are for CW0. NDI2 indicates which TB is enabled. MCS2 signals the rank-1 precoding vector using 24 hypotheses out of 32. For TRI=2, use rank=2 with both TBs enabled. MCS1 and NDI1 are for CW0. MCS2 and NDI2 are for CW1.

For 4 Tx there is a 5-bit precoding field. For PMI=0, use rank-1 with one TB enabled. MCS1 and NDI1 are for CW0. NDI2 indicates which TB is enabled. MCS2 signals the rank-1 precoding vector using 24 hypotheses out of 32. PMI>0 indicates TRI>1. For PMI=1, use rank-2 with one TB enabled. MCS1 and NDI1 are for CW0. NDI2 indicates which TB is enabled. MCS2 signals the rank-2 precoding vector using 16 hypotheses out of 32. For PMI of 2-17, use rank-2 with both TBs enabled. MCS1 and NDI1 are for CW0. MCS2 and NDI2 are for CW1. For PMI of 18-29, use rank-3 with both TBs enabled. MCS1 and NDI1 are for CW0. MCS2 and NDI2 are for CW1. For PMI=30, use rank-4 with both TBs enabled. MCS1 and NDI1 are for CW0. MCS2 and NDI2 are for CW1. A PMI of 31 is reserved.

In case of 5-bit MCS and n-bit differential MCS uplink, the differential MCS field is jointly encoded with the TB enabling/disabling. This is shown in Table 23 where n=4.

TABLE 23

| Delta_MCS | |
|---|---|
| Indices | Interpretation |
| 0-12 | Both TBs are enabled. Primary |
| | MCS for TB1, Delta_MCS for TB2 |
| | with MCS values relative to |
| | Primary MCS, e.g., [−6, −5, . . . , |
| | 0, . . . , 5, 6] |
| 13 | TB1 enabled/TB2 disabled |
| | Primary MCS for TB1 |
| 14 | TB1 disabled/TB2 enabled |
| | Primary MCS for TB2 |
| 15 | Reserved |

This scheme only works when a differential MCS field is adopted. Such a differential MCS is only feasible under HARQ bundling where 1-TB with 2-layer transmission is not needed anyway. Thus this technique is not needed.

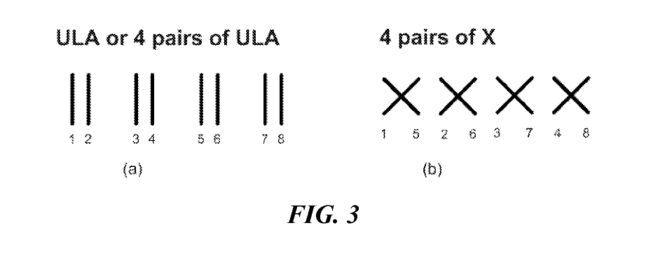

The design of 8 Tx codebook for downlink (DL) MIMO is tightly coupled with the feedback framework for the enhanced DL MIMO. This application assumes the following antenna element indexing to enumerate the spatial channel coefficients H_{n,m} where n is the receiver antenna index and m is the transmitter antenna index. FIG. 3b illustrates the indexing for the 4 pairs of cross-polarized antennas. This grouping of two antennas have the same polarization which tend to be more correlated. This is analogous to the indexing of 4 pairs of Uniform linear array (ULA) shown in FIG. 3a.

A particular dual-stage feedback structure of interest is based on the product structure.

W=W₁W₂ (1)

W₁ targets wideband/long-term channel properties and W₂ targets frequency-selective/short-term channel properties. Each of the components is assigned a codebook. Two distinct codebooks CB₁ and CB² are needed. W is the composite precoder. The choice between W1 and W₂ is indicated via PMI₁ and PMI₂. The following guidelines are enforced in our proposed design for the composite precoder.

While the design is aimed for various antenna setups and spatial channel conditions, priority is given to the following three 8 Tx setups with more weight given to the first and second scenarios:

(1) Uniform linear array (ULA) with λ/2 (half wavelength) spacing and at least 16 DFT vectors;

(2) 4 dual-polarized elements with λ/2 spacing between two elements and at least 8 DFT vectors per co-polarized group; and

(3) 4 dual-polarized elements with 4 (larger) spacing between two elements.

Based on the first guideline, the first priority should be given to rank-1 and 2, while the second given to rank-3 and 4. It is expected that precoding gain is not substantial for rank-5 and higher. Priority is associated with the extent of optimization effort as well as the allocated feedback signaling overhead. In this contribution, the codebook designs for rank-5 and above are not given.

Each matrix element belongs to a finite set of values or constellation, the M-PSK alphabet.

All elements in a precoding matrix have the same magnitude in Constant modulus for W. This is important to facilitate power amplifier (PA) balance property in all scenarios. Note that constant modulus is a sufficient but not necessary condition for PA balance. Enforcing a constant modulus property tends to result in a simpler codebook design. While the precoding codebook for feedback conforms to the constant modulus property, this does not restrict the eNodeB from using a non-constant modulus precoder. This is possible using a UE-specific RS for demodulation.

In a Nested property every matrix/vector of rank-n is a sub-matrix of a rank-(n+1) precoding matrix, n=1, 2, . . . , N−1 where N is the maximum number of layers. While this property is desirable as it allows to reduce the complexity of PMI selection, it is not necessary to facilitate rank override if UE-specific RS is used.

The associated feedback signaling overhead should be minimized. This is achieved by a good balance between the overhead associated with W₁ (wideband, long-term) and W_{2 (sub-band, short-term). Both time (feedback rate) and frequency (feedback granularity) dimensions are important. Blindly increasing the size of CB}₁ while reducing the size of CB₂ does not guarantee reducing the overall feedback overhead if a certain level of performance is expected. If the codebook CB₁ is meant to cover a certain precoder sub-space with a given spatial resolution, increasing the size of CB₁ demands an increase in feedbacks signaling associated with W₁ both in time and frequency. This is because CB₁ start to capture shorter-term channel properties which are meant to be parts of CB₂. To ensure that CB₁ does not need to be updated too frequently in time and frequency, CB₁ should capture long-term channel properties such as the 8 Tx antenna setup and a range of values of angle of departure (AoD) which are associated with spatial correlation.

A Unitary precoder has column vectors of a precoder matrix that are pair-wise orthogonal to one another. This is a sufficient but not necessary condition for maintaining constant average transmitted power. This constraint is also used in designing the codebook at least for some relevant ranks.

This section describes a design consisting of two sets. The first set targets the ULA setup. The second set targets the cross-polarized setup. The two sets are combined into one codebook following the dual-stage framework.

### Set 1

The first set includes a set of 16 DFT vectors can be generated from the 2 times oversampled DFT matrices as follows.

$${w}_{1}^{( n )} = \frac{1}{2 \sqrt{2}} \times [ \begin{matrix}1 & 0 & … & 0 \\ 0 & {( - 1 )}^{n} & … & 0 \\ ⋮ & ⋮ & ⋱ & ⋮ \\ 0 & 0 & … & {( - 1 )}^{7 n}\end{matrix} ] [ \begin{matrix}1 & 1 & … & 1 \\ 1 & {e}^{j \frac{π}{8}} & … & {e}^{j ( 7 ) \frac{π}{8}} \\ ⋮ & ⋮ & ⋱ & ⋮ \\ 1 & {e}^{j ( 7 ) \frac{π}{8}} & … & {e}^{j ( 7 ) ( 7 ) \frac{π}{8}}\end{matrix} ] , \\ n = 0 , 1 \\ {CB}_{1} = \{ {W}_{1}^{( 0 )} , {W}_{1}^{( 1 )} \} \qquad ( 2 )$$

This construction in equation (2) divides the “beam angle” space into 2 partitions:

$$\{ \frac{π}{8} m , m = 0 , 1 , … , 7 \} and \{ \frac{π}{8} m , m = 8 , 9 , … , 15 \} .$$

Each UE may update PMI₁ and thus W₁ at a lower rate as the Angle of Arrival (AoA) region in which each UE resides changes slowly. The precise AoA may change at a faster rate. This is adapted with the change of W₂ which is associated with CB₂.

CB₁ is use to design CB₂ for all the relevant ranks. The following design is proposed. For a given rank, CB₂ performs column vector selection or group selection within a given W₁ matrix. For rank-2, 3 and 4, CB₂ is designed such that the unitary precoder constraint is fulfilled.

Denoting a length-8 column vector with 1 in the n-th row and zero elements elsewhere as eₙ, for example e₁=[1 0 0 0 0 0 0]^{T} and e₅=[0 0 0 0 1 0 0 0]^{T}. the following design of CB₂ is constructed:

Rank-1: size-8

{e₁,e₂,e₃,e₄,e₅,e₆,e₇,e₈}

Rank-2: size-12

$$\{ \begin{matrix}[ \begin{matrix}{e}_{1} & {e}_{3}\end{matrix} ] , [ \begin{matrix}{e}_{1} & {e}_{5}\end{matrix} ] , [ \begin{matrix}{e}_{1} & {e}_{7}\end{matrix} ] , [ \begin{matrix}{e}_{2} & {e}_{4}\end{matrix} ] , [ \begin{matrix}{e}_{2} & {e}_{6}\end{matrix} ] , [ \begin{matrix}{e}_{2} & {e}_{8}\end{matrix} ] , \\ [ \begin{matrix}{e}_{3} & {e}_{5}\end{matrix} ] , [ \begin{matrix}{e}_{3} & {e}_{7}\end{matrix} ] , [ \begin{matrix}{e}_{4} & {e}_{6}\end{matrix} ] , [ \begin{matrix}{e}_{4} & {e}_{8}\end{matrix} ] , [ \begin{matrix}{e}_{5} & {e}_{7}\end{matrix} ] , [ \begin{matrix}{e}_{6} & {e}_{8}\end{matrix} ]\end{matrix} \}$$

Rank-3: size-8

$$\{ \begin{matrix}[ \begin{matrix}{e}_{1} & {e}_{3} & {e}_{5}\end{matrix} ] , [ \begin{matrix}{e}_{1} & {e}_{3} & {e}_{7}\end{matrix} ] , [ \begin{matrix}{e}_{1} & {e}_{5} & {e}_{7}\end{matrix} ] , [ \begin{matrix}{e}_{3} & {e}_{5} & {e}_{7}\end{matrix} ] \\ [ \begin{matrix}{e}_{2} & {e}_{4} & {e}_{6}\end{matrix} ] , [ \begin{matrix}{e}_{2} & {e}_{4} & {e}_{8}\end{matrix} ] , [ \begin{matrix}{e}_{2} & {e}_{6} & {e}_{8}\end{matrix} ] , [ \begin{matrix}{e}_{4} & {e}_{6} & {e}_{8}\end{matrix} ]\end{matrix} \}$$

Rank-4: size-2

{[e₁ e₃ e₅ e₇],[e₂ e₄ e₆ e₈]}

More designed freedom can be obtained if the unitary constraint is relaxed. In that case, some scaling inversely proportional to Trace {W^{H} W} needs to be performed. This attempts to limit the overhead associated with PMI₂ to 4 bits per report. This results in the same PMI payload as Rel-8/9 4 Tx closed-loop spatial multiplexing.

### Set 2

The second set is a refinement has four pairs of dual-polarized antennas, the spatial channel covariance matrix can be approximated as follows:

$$C \approx [ \begin{matrix}{C}_{H} & 0 \\ 0 & {C}_{V}\end{matrix} ] = [ \begin{matrix}{C}_{ULA \text{-} 4} & 0 \\ 0 & {C}_{ULA \text{-} 4}\end{matrix} ] \qquad ( 3 )$$

The 4×4 covariance matrices C_{H} and C_{V} follow that of the 4 Tx ULA. The spatial covariance matrix is block diagonal since the spatial channel coefficients associated with different polarizations are uncorrelated. Even with λ/2 spacing, a rank-2 transmission can occur quite often. This assumes that the elements associated with different polarization groups are combined via the second stage precoding (see equation (4) below where Y collapses the two polarization groups into one).

$$\begin{matrix}W = [ \begin{matrix}{α}_{H} XY \\ {α}_{V} XY\end{matrix} ] \\ = [ \begin{matrix}{α}_{H} \\ {α}_{V}\end{matrix} ] ⊗ ( XY ) \\ = α ⊗ ( XY ) \\ = [ \begin{matrix}X & 0 \\ 0 & X\end{matrix} ] ( α ⊗ Y ) \\ ≡ {W}_{1} {W}_{2}\end{matrix} \qquad ( 4 )$$

This scheme does not allow transmission higher than rank-4. In fact, rank>1 will not occur frequently with λ/2 spacing. It is then apparent that the formulation in equation (4) is more suitable for rank-1 transmission in this particular antenna setup. While this scheme may increase precoding diversity gain, the two different polarization groups should also be used spatial multiplexing due to the uncorrelated nature of the different polarization groups. To take advantage of such property, the formulation in equation (4) can be expanded as follows:

$$W = [ \begin{matrix}X & 0 \\ 0 & X\end{matrix} ] [ \begin{matrix}{α}_{HH} {Y}_{1} & {α}_{HV} {Y}_{2} \\ {α}_{VH} {Y}_{1} & {α}_{VV} {Y}_{2}\end{matrix} ] ≡ {W}_{1} {W}_{2} \qquad ( 5 )$$

The formulation in equation (5) is reduced to equation (4) when α_{HV} and α_{VV} are set to zero. Also, Y₁ and Y₂ can be the same or different.

To generate at least 8 DFT vectors per polarization group, the following design for W₁ based on the 4x oversampled 4 Tx DFT vectors is used. The beam angle space is partitioned into 2 groups rather than 4, resulting in W₁ of size 8×16 block diagonal matrix since X is a 4×8 matrix:

$${X}^{( n )} = \frac{1}{2} \times [ \begin{matrix}1 & 0 & 0 & 0 \\ 0 & {( - 1 )}^{n} & 0 & 0 \\ 0 & 0 & 1 & 0 \\ 0 & 0 & 0 & {( - 1 )}^{n}\end{matrix} ] [ \begin{matrix}1 & 1 & 1 & … & 1 \\ 1 & {e}^{j \frac{π}{8}} & {e}^{j ( 2 ) \frac{π}{8}} & … & {e}^{j ( 7 ) \frac{π}{8}} \\ 1 & {e}^{j ( 2 ) \frac{π}{8}} & {e}^{j ( 2 ) ( 2 ) \frac{π}{8}} & … & {e}^{j ( 7 ) ( 2 ) \frac{π}{8}} \\ 1 & {e}^{j ( 3 ) \frac{π}{8}} & {e}^{j ( 2 ) ( 3 ) \frac{π}{8}} & … & {e}^{j ( 7 ) ( 3 ) \frac{π}{8}}\end{matrix} ] , \\ n = 0 , 1 \\ {W}_{1}^{( n )} = [ \begin{matrix}{X}^{( n )} & 0 \\ 0 & {X}^{( n )}\end{matrix} ] , \\ {CB}_{1} = \{ {W}_{1}^{( 0 )} , {W}_{1}^{( 1 )} \} \qquad ( 6 )$$

It is also possible to use the 2 times oversampled 4 Tx DFT vectors since we only need eight vectors. The number of possible precoding vectors/matrices that can be synthesized from column vector selection (associated with Y, Y₁ and/or Y₂) is smaller especially when the unitary precoder constraint is enforced for higher rank precoders. In this case, the number of W₂ matrices can be increased by increasing the number of co-phasing vectors/matrices associated with the α parameters. An example of such design is given below.

The short-term and/or frequency-selective component W₂ is constructed based on the formulation in equation (4) for rank-1 and equation (5) for higher ranks. The overhead associated with W₂ is kept within 4 bits similar to Set 1. For a given rank, only a subset of all possible combinations is used when the number of all possible combinations exceeds 16. The unitary precoder is constrained to rank-2, 3 and 4.

Rank-1: size-16

$${W}_{2} ∈ {CB}_{2} = \{ \frac{1}{\sqrt{2}} [ \begin{matrix}Y \\ Y\end{matrix} ] , \frac{1}{\sqrt{2}} [ \begin{matrix}Y \\ jY\end{matrix} ] , \frac{1}{\sqrt{2}} [ \begin{matrix}Y \\ - Y\end{matrix} ] , \frac{1}{\sqrt{2}} [ \begin{matrix}Y \\ - jY\end{matrix} ] \} \\ Y ∈ \{ {e}_{1} , {e}_{3} , {e}_{5} , {e}_{7} \} \qquad ( 7 )$$

Only 4 out of 8 rank-1 precoding vectors are used. This fulfills the constraint of generating a total of eight 4 Tx DFT vectors since each one of the two W₁ matrices permits the generation of four 4 Tx DFT vectors.
Rank-2: size-16

$${W}_{2} ∈ {CB}_{2} = \{ \frac{1}{\sqrt{2}} [ \begin{matrix}Y & Y \\ Y & - Y\end{matrix} ] , \frac{1}{\sqrt{2}} [ \begin{matrix}Y & Y \\ jY & - jY\end{matrix} ] \} \\ Y ∈ \{ {e}_{1} , {e}_{2} , {e}_{3} , {e}_{4} , {e}_{5} , {e}_{6} , {e}_{7} , {e}_{8} \} \qquad ( 8 )$$

Rank-3: size-16

$${W}_{2} ∈ {CB}_{2} = \{ \frac{1}{\sqrt{2}} [ \begin{matrix}{Y}_{1} & {Y}_{2} \\ {Y}_{1} & - {Y}_{2}\end{matrix} ] , \frac{1}{\sqrt{2}} [ \begin{matrix}{Y}_{1} & {Y}_{2} \\ {jY}_{1} & - {jY}_{2}\end{matrix} ] \} \\ ( {Y}_{1} , {Y}_{2} ) ∈ \{ \begin{matrix}( {e}_{1} , [ \begin{matrix}{e}_{1} & {e}_{5}\end{matrix} ] ) , ( {e}_{2} , [ \begin{matrix}{e}_{2} & {e}_{6}\end{matrix} ] ) , ( {e}_{3} , [ \begin{matrix}{e}_{3} & {e}_{7}\end{matrix} ] ) , ( {e}_{4} , [ \begin{matrix}{e}_{4} & {e}_{8}\end{matrix} ] ) , \\ ( {e}_{5} , [ \begin{matrix}{e}_{1} & {e}_{5}\end{matrix} ] ) , ( {e}_{6} , [ \begin{matrix}{e}_{2} & {e}_{6}\end{matrix} ] ) , ( {e}_{7} , [ \begin{matrix}{e}_{3} & {e}_{7}\end{matrix} ] ) , ( {e}_{8} , [ \begin{matrix}{e}_{4} & {e}_{8}\end{matrix} ] )\end{matrix} \} \qquad ( 9 )$$

Rank-4: size-8

$${W}_{2} ∈ {CB}_{2} = \{ \frac{1}{\sqrt{2}} [ \begin{matrix}Y & Y \\ Y & - Y\end{matrix} ] , \frac{1}{\sqrt{2}} [ \begin{matrix}Y & Y \\ jY & - jY\end{matrix} ] \} \\ Y ∈ \{ [ \begin{matrix}{e}_{1} & {e}_{5}\end{matrix} ] , [ \begin{matrix}{e}_{2} & {e}_{6}\end{matrix} ] , [ \begin{matrix}{e}_{3} & {e}_{7}\end{matrix} ] , [ \begin{matrix}{e}_{4} & {e}_{8}\end{matrix} ] \} \qquad ( 10 )$$

While this design is geared towards an array of 4 dual-polarized antennas with λ/2 spacing, this design performs reasonably well for an array of 4 dual-polarized antennas with 4A spacing which represents a nearly-uncorrelated spatial channel.

### Set 1+Set 2=Combined Set

Set 1 and 2 are combined to form a single codebook. The combined set can be described as follows: The combined CB₁ consists of 4 matrices. Thus 2 bits are needed for PMI₁ signaling. For a given W₁ matrix taken from CB₁, the second codebook CB₂ associated with the second precoder W₂ is given as described above with respect to Set 1 and Set 2. Since the size of CB₂ is confined to 16, 4 bits are required for PMI₂ signalling. This technique does not require any new PUCCH format design.

Since PMI₁ only requires 2 bits of signaling, it can be reported together with RI without significantly increasing the risk of error propagation for either PMI₁ or RI. Note that RI is reported with PUCCH format 2/2a/2b which is heavily protected. To support 8 Tx, a total of 3+2=5 bits of payload is expected when RI and PMI₁ are transmitted together. Some further optimization can be done to reduce the payload such as a mechanism similar to codebook subset restriction. It is possible to report RI and PMI₁ separately resulting in better protection at the expense of utilizing more PUCCH resources.

PMI₂ requires 4 bits of signaling which is the same as 4 Tx closed-loop spatial multiplexing in Rel-8/9. Assuming that the resolution of CQI is kept the same as Rel-8/9, a new PUCCH payload is not needed since the payload is still kept less than or equal to 11 bits.

The number of precoders may be reduced due to the possibility of overlap between Set 1 and Set 2. Analogous to the FFT algorithm, an 8 Tx ULA vector can be synthesized from two 4 Tx ULA vectors using a phase offset to the second 4 Tx ULA vector. It is unclear how much overhead saving can be obtained without sacrificing the long-term vs. short-term separation in time and frequency between CB₁ and CB₂. An example of such design is given below.

While codebook designs for rank-5 and above are not detailed in this application, any construction within the sphere of the presented design framework can complement the proposed construction for rank-1 to 4. Due to the marginal precoding gain for the higher rank transmission, it is expected that a very small codebook size of 1 to 4 matrices per rank will suffice.

If the 2 times oversampled 4 Tx DFT vectors are used, the following design is possible:

$${X}^{( n )} = \frac{1}{2} \times [ \begin{matrix}1 & 0 & 0 & 0 \\ 0 & {( - 1 )}^{n} & 0 & 0 \\ 0 & 0 & 1 & 0 \\ 0 & 0 & 0 & {( - 1 )}^{n}\end{matrix} ] [ \begin{matrix}1 & 1 & 1 & 1 \\ 1 & {e}^{j \frac{π}{4}} & {e}^{j ( 2 ) \frac{π}{4}} & {e}^{j ( 3 ) \frac{π}{4}} \\ 1 & {e}^{j ( 2 ) \frac{π}{4}} & {e}^{j ( 2 ) ( 2 ) \frac{π}{4}} & {e}^{j ( 3 ) ( 2 ) \frac{π}{4}} \\ 1 & {e}^{j ( 3 ) \frac{π}{4}} & {e}^{j ( 2 ) ( 3 ) \frac{π}{4}} & {e}^{j ( 3 ) ( 3 ) \frac{π}{4}}\end{matrix} ] , \\ n = 0 , 1 \\ {W}_{1}^{( n )} = [ \begin{matrix}{X}^{( n )} & 0 \\ 0 & {X}^{( n )}\end{matrix} ] , \\ {CB}_{1} = \{ {W}_{1}^{( 0 )} , {W}_{1}^{( 1 )} \} \qquad ( 11 )$$

Rank-1: size-16

$${W}_{2} ∈ {CB}_{2} = \{ \frac{1}{\sqrt{2}} [ \begin{matrix}Y \\ Y\end{matrix} ] , \frac{1}{\sqrt{2}} [ \begin{matrix}Y \\ jY\end{matrix} ] , \frac{1}{\sqrt{2}} [ \begin{matrix}Y \\ - Y\end{matrix} ] , \frac{1}{\sqrt{2}} [ \begin{matrix}Y \\ - jY\end{matrix} ] \} \\ Y ∈ \{ [ \begin{matrix}1 \\ 0 \\ 0 \\ 0\end{matrix} ] , [ \begin{matrix}0 \\ 1 \\ 0 \\ 0\end{matrix} ] , [ \begin{matrix}0 \\ 0 \\ 1 \\ 0\end{matrix} ] , [ \begin{matrix}0 \\ 0 \\ 0 \\ 1\end{matrix} ] \} \qquad ( 12 )$$

For rank-2, 3 and 4 designs the resolution of the co-phasing matrices is increased to generate more W₂ matrices. It is also possible to use such higher co-phasing resolution to construct the rank-1 codebook if more vectors are desired. For example, a size-32 rank-1 CB₂ can be obtained as follows:

$${W}_{2} ∈ {CB}_{2} = \{ \frac{1}{\sqrt{2}} [ \begin{matrix}Y \\ {e}^{j \frac{π}{4} k} Y\end{matrix} ] , k = 0 , 1 , 2 , 3 … , 7 \}$$

$$Y ∈ \{ [ \begin{matrix}1 \\ 0 \\ 0 \\ 0\end{matrix} ] , [ \begin{matrix}0 \\ 1 \\ 0 \\ 0\end{matrix} ] , [ \begin{matrix}0 \\ 0 \\ 1 \\ 0\end{matrix} ] , [ \begin{matrix}0 \\ 0 \\ 0 \\ 1\end{matrix} ] \}$$

Rank-2: size-16

$${W}_{2} ∈ {CB}_{2} = \{ \frac{1}{\sqrt{2}} [ \begin{matrix}Y & Y \\ {e}^{j \frac{π}{4} k} Y & - {e}^{j \frac{π}{4} k} Y\end{matrix} ] , k = 0 , 1 , 2 , 3 \} \\ Y ∈ \{ [ \begin{matrix}1 \\ 0 \\ 0 \\ 0\end{matrix} ] , [ \begin{matrix}0 \\ 1 \\ 0 \\ 0\end{matrix} ] , [ \begin{matrix}0 \\ 0 \\ 1 \\ 0\end{matrix} ] , [ \begin{matrix}0 \\ 0 \\ 0 \\ 1\end{matrix} ] \} \qquad ( 13 )$$

Rank-3: size-16

$${W}_{2} ∈ {CB}_{2} = \{ \frac{1}{\sqrt{2}} [ \begin{matrix}{Y}_{1} & {Y}_{2} \\ {e}^{j \frac{π}{4} k} {Y}_{1} & - {e}^{j \frac{π}{4} k} {Y}_{2}\end{matrix} ] , k = 0 , 1 , 2 , 3 \} \\ ( {Y}_{1} , {Y}_{2} ) ∈ \{ ( [ \begin{matrix}1 \\ 0 \\ 0 \\ 0\end{matrix} ] , [ \begin{matrix}1 & 0 \\ 0 & 0 \\ 0 & 1 \\ 0 & 0\end{matrix} ] ) , ( [ \begin{matrix}0 \\ 1 \\ 0 \\ 0\end{matrix} ] , [ \begin{matrix}0 & 0 \\ 1 & 0 \\ 0 & 0 \\ 0 & 1\end{matrix} ] ) , ( [ \begin{matrix}0 \\ 0 \\ 1 \\ 0\end{matrix} ] , [ \begin{matrix}1 & 0 \\ 0 & 0 \\ 0 & 1 \\ 0 & 0\end{matrix} ] ) , ( [ \begin{matrix}0 \\ 0 \\ 0 \\ 1\end{matrix} ] , [ \begin{matrix}0 & 0 \\ 1 & 0 \\ 0 & 0 \\ 0 & 1\end{matrix} ] ) \} \qquad ( 14 )$$

Rank-4: size-8

$${W}_{2} ∈ {CB}_{2} = \{ \frac{1}{\sqrt{2}} [ \begin{matrix}Y & Y \\ {e}^{j \frac{π}{4} k} Y & - {e}^{j \frac{π}{4} k} Y\end{matrix} ] , k = 0 , 1 , 2 , 3 \} \\ Y ∈ \{ [ \begin{matrix}1 & 0 \\ 0 & 0 \\ 0 & 1 \\ 0 & 0\end{matrix} ] [ \begin{matrix}0 & 0 \\ 1 & 0 \\ 0 & 0 \\ 0 & 1\end{matrix} ] \} \qquad ( 15 )$$

Sixteen 8 Tx DFT vectors can be synthesized from Set 2 by using the butterfly property employing the phase shift on the second 4 Tx DFT vector. Thus the design methodology for Set 1 is not used. The partitioning of the beam angle needs to be modified to ensure that the payload for W₂ still falls within 4 bits. The W₁ matrix can be rank-specific.

The codebook example covers rank-1 to 4 and is thus a multi-rank) format. Any multi-rank design constructed from taking at least one rank-specific codebook(s) from one example and some other rank-specific codebook(s) from other example(s) is not precluded. For instance, a multi-rank codebook may be constructed using the rank-1 and 2 codebooks from Example 3A combined with rank-3 and 4 codebooks from Example 3B. It is also possible to construct a multi-rank codebook from a subset of a design. For example a multi-rank codebook which uses the rank-1 and 2 designs from any of the examples below may be constructed using a fixed matrix precoding (“size-1 codebook”) for rank-3 and above.

### Example 1A

### Use the Same CB₁ is Used for All Ranks

$${X}^{( n )} = \frac{1}{2} \times [ \begin{matrix}1 & 0 & 0 & 0 \\ 0 & {( j )}^{n} & 0 & 0 \\ 0 & 0 & 1 & 0 \\ 0 & 0 & 0 & {( - j )}^{n}\end{matrix} ] [ \begin{matrix}1 & 1 & 1 & 1 \\ 1 & {e}^{j \frac{π}{8}} & {e}^{j ( 2 ) \frac{π}{8}} & {e}^{j ( 3 ) \frac{π}{8}} \\ 1 & {e}^{j ( 2 ) \frac{π}{8}} & {e}^{j ( 2 ) ( 2 ) \frac{π}{8}} & {e}^{j ( 3 ) ( 2 ) \frac{π}{8}} \\ 1 & {e}^{j ( 3 ) \frac{π}{8}} & {e}^{j ( 2 ) ( 3 ) \frac{π}{8}} & {e}^{j ( 3 ) ( 3 ) \frac{π}{8}}\end{matrix} ] , \\ n = 0 , 1 , 2 , 3$$

$${CB}_{1} size - 4$$

$${W}_{1}^{( n )} = [ \begin{matrix}{X}^{( n )} & 0 \\ 0 & {X}^{( n )}\end{matrix} ] , {CB}_{1} = \{ {W}_{1}^{( 0 )} , {W}_{1}^{( 1 )} , {W}_{1}^{( 2 )} , {W}_{1}^{( 3 )} \}$$

Here, X is a 4 times oversampled 4 TxDFT matrix with level-4 partition.
Rank-1: CB₂ size-16

$${W}_{2} ∈ {CB}_{2} = \{ \frac{1}{\sqrt{2}} [ \begin{matrix}Y \\ Y\end{matrix} ] , \frac{1}{\sqrt{2}} [ \begin{matrix}Y \\ j Y\end{matrix} ] , \frac{1}{\sqrt{2}} [ \begin{matrix}Y \\ - Y\end{matrix} ] , \frac{1}{\sqrt{2}} [ \begin{matrix}Y \\ - j Y\end{matrix} ] \}$$

$$Y ∈ \{ [ \begin{matrix}1 \\ 0 \\ 0 \\ 0\end{matrix} ] , [ \begin{matrix}0 \\ 1 \\ 0 \\ 0\end{matrix} ] , [ \begin{matrix}0 \\ 0 \\ 1 \\ 0\end{matrix} ] , [ \begin{matrix}0 \\ 0 \\ 0 \\ 1\end{matrix} ] \}$$

Rank-2: CB₂ size-16

$${W}_{2} ∈ {CB}_{2} = \{ \frac{1}{\sqrt{2}} [ \begin{matrix}Y & Y \\ {e}^{j \frac{π}{4} k} Y & - {e}^{j \frac{π}{4} k} Y\end{matrix} ] , k = 0 , 1 , 2 , 3 \}$$

$$Y ∈ \{ [ \begin{matrix}1 \\ 0 \\ 0 \\ 0\end{matrix} ] , [ \begin{matrix}0 \\ 1 \\ 0 \\ 0\end{matrix} ] , [ \begin{matrix}0 \\ 0 \\ 1 \\ 0\end{matrix} ] , [ \begin{matrix}0 \\ 0 \\ 0 \\ 1\end{matrix} ] \}$$

Rank-3: CB₂ size-16

$${W}_{2} ∈ {CB}_{2} = \{ \frac{1}{\sqrt{2}} [ \begin{matrix}{Y}_{1} & {Y}_{2} \\ {e}^{j \frac{π}{4} k} {Y}_{1} & - {e}^{j \frac{π}{4} k} {Y}_{2}\end{matrix} ] , k = 0 , 1 , 2 , 3 \}$$

$$( {Y}_{1} , {Y}_{2} ) ∈ \{ \begin{matrix}( [ \begin{matrix}1 \\ 0 \\ 0 \\ 0\end{matrix} ] , [ \begin{matrix}1 & 0 \\ 0 & 0 \\ 0 & 1 \\ 0 & 0\end{matrix} ] ) , ( [ \begin{matrix}0 \\ 1 \\ 0 \\ 0\end{matrix} ] , [ \begin{matrix}0 & 0 \\ 1 & 0 \\ 0 & 0 \\ 0 & 1\end{matrix} ] ) , \\ ( [ \begin{matrix}0 \\ 0 \\ 1 \\ 0\end{matrix} ] , [ \begin{matrix}1 & 0 \\ 0 & 0 \\ 0 & 1 \\ 0 & 0\end{matrix} ] ) , ( [ \begin{matrix}0 \\ 0 \\ 0 \\ 1\end{matrix} ] , [ \begin{matrix}0 & 0 \\ 1 & 0 \\ 0 & 0 \\ 0 & 1\end{matrix} ] )\end{matrix} \}$$

Rank-4: CB₂ size-8

$${W}_{2} ∈ {CB}_{2} = \{ \frac{1}{\sqrt{2}} [ \begin{matrix}Y & Y \\ {e}^{j \frac{π}{4} k} Y & - {e}^{j \frac{π}{4} k} Y\end{matrix} ] , k = 0 , 1 , 2 , 3 \}$$

$$Y ∈ \{ [ \begin{matrix}1 & 0 \\ 0 & 0 \\ 0 & 1 \\ 0 & 0\end{matrix} ] , [ \begin{matrix}0 & 0 \\ 1 & 0 \\ 0 & 0 \\ 0 & 1\end{matrix} ] \}$$

### Example 1B

### Similar to Example 1A, Smaller CB₂ for Higher Ranks

$${X}^{( n )} = \frac{1}{2} \times [ \begin{matrix}1 & 0 & 0 & 0 \\ 0 & {( j )}^{n} & 0 & 0 \\ 0 & 0 & 1 & 0 \\ 0 & 0 & 0 & {( - j )}^{n}\end{matrix} ] [ \begin{matrix}1 & 1 & 1 & 1 \\ 1 & {e}^{j \frac{π}{8}} & {e}^{j ( 2 ) \frac{π}{8}} & {e}^{j ( 3 ) \frac{π}{8}} \\ 1 & {e}^{j ( 2 ) \frac{π}{8}} & {e}^{j ( 2 ) ( 2 ) \frac{π}{8}} & {e}^{j ( 3 ) ( 2 ) \frac{π}{8}} \\ 1 & {e}^{j ( 3 ) \frac{π}{8}} & {e}^{j ( 2 ) ( 3 ) \frac{π}{8}} & {e}^{j ( 3 ) ( 3 ) \frac{π}{8}}\end{matrix} ] , \\ n = 0 , 1 , 2 , 3$$

$${CB}_{1} size - 4$$

$${W}_{1}^{( n )} = [ \begin{matrix}{X}^{( n )} & 0 \\ 0 & {X}^{( n )}\end{matrix} ] , {CB}_{1} = \{ {W}_{1}^{( 0 )} , {W}_{1}^{( 1 )} , {W}_{1}^{( 2 )} , {W}_{1}^{( 3 )} \}$$

Rank-1: CB₂ size-16

$${W}_{2} ∈ {CB}_{2} = \{ \frac{1}{\sqrt{2}} [ \begin{matrix}Y \\ Y\end{matrix} ] , \frac{1}{\sqrt{2}} [ \begin{matrix}Y \\ j Y\end{matrix} ] , \frac{1}{\sqrt{2}} [ \begin{matrix}Y \\ - Y\end{matrix} ] , \frac{1}{\sqrt{2}} [ \begin{matrix}Y \\ - j Y\end{matrix} ] \}$$

$$Y ∈ \{ [ \begin{matrix}1 \\ 0 \\ 0 \\ 0\end{matrix} ] , [ \begin{matrix}0 \\ 1 \\ 0 \\ 0\end{matrix} ] , [ \begin{matrix}0 \\ 0 \\ 1 \\ 0\end{matrix} ] , [ \begin{matrix}0 \\ 0 \\ 0 \\ 1\end{matrix} ] \}$$

Rank-2: CB₂ size-8

$${W}_{2} ∈ {CB}_{2} = \{ \frac{1}{\sqrt{2}} [ \begin{matrix}Y & Y \\ Y & - Y\end{matrix} ] , \frac{1}{\sqrt{2}} [ \begin{matrix}Y & Y \\ j Y & - j Y\end{matrix} ] \}$$

$$Y ∈ \{ [ \begin{matrix}1 \\ 0 \\ 0 \\ 0\end{matrix} ] , [ \begin{matrix}0 \\ 1 \\ 0 \\ 0\end{matrix} ] , [ \begin{matrix}0 \\ 0 \\ 1 \\ 0\end{matrix} ] , [ \begin{matrix}0 \\ 0 \\ 0 \\ 1\end{matrix} ] \}$$

Rank-3: CB₂ size-8

$${W}_{2} ∈ {CB}_{2} = \{ \frac{1}{\sqrt{2}} [ \begin{matrix}Y & Y \\ Y & - Y\end{matrix} ] , \frac{1}{\sqrt{2}} [ \begin{matrix}Y & Y \\ j Y & - j Y\end{matrix} ] \}$$

$$( {Y}_{1} , {Y}_{2} ) ∈ \{ \begin{matrix}( [ \begin{matrix}1 \\ 0 \\ 0 \\ 0\end{matrix} ] , [ \begin{matrix}1 & 0 \\ 0 & 0 \\ 0 & 1 \\ 0 & 0\end{matrix} ] ) , ( [ \begin{matrix}0 \\ 1 \\ 0 \\ 0\end{matrix} ] , [ \begin{matrix}0 & 0 \\ 1 & 0 \\ 0 & 0 \\ 0 & 1\end{matrix} ] ) , \\ ( [ \begin{matrix}0 \\ 0 \\ 1 \\ 0\end{matrix} ] , [ \begin{matrix}1 & 0 \\ 0 & 0 \\ 0 & 1 \\ 0 & 0\end{matrix} ] ) , ( [ \begin{matrix}0 \\ 0 \\ 0 \\ 1\end{matrix} ] , [ \begin{matrix}0 & 0 \\ 1 & 0 \\ 0 & 0 \\ 0 & 1\end{matrix} ] )\end{matrix} \}$$

Rank-4: CB₂ size-4

$${W}_{2} ∈ {CB}_{2} = \{ \frac{1}{\sqrt{2}} [ \begin{matrix}Y & Y \\ Y & - Y\end{matrix} ] , \frac{1}{\sqrt{2}} [ \begin{matrix}Y & Y \\ j Y & - j Y\end{matrix} ] \}$$

$$Y ∈ \{ [ \begin{matrix}1 & 0 \\ 0 & 0 \\ 0 & 1 \\ 0 & 0\end{matrix} ] , [ \begin{matrix}0 & 0 \\ 1 & 0 \\ 0 & 0 \\ 0 & 1\end{matrix} ] \}$$

### Example 2A

### May Use Rank-specific CB₁

Rank-1: CB₁ size-4, CB₂ size-16

$${X}^{( n )} = \frac{1}{2} \times [ \begin{matrix}1 & 0 & 0 & 0 \\ 0 & {( j )}^{n} & 0 & 0 \\ 0 & 0 & 1 & 0 \\ 0 & 0 & 0 & {( - j )}^{n}\end{matrix} ] [ \begin{matrix}1 & 1 & 1 & 1 \\ 1 & {e}^{j \frac{π}{8}} & {e}^{j ( 2 ) \frac{π}{8}} & {e}^{j ( 3 ) \frac{π}{8}} \\ 1 & {e}^{j ( 2 ) \frac{π}{8}} & {e}^{j ( 2 ) ( 2 ) \frac{π}{8}} & {e}^{j ( 3 ) ( 2 ) \frac{π}{8}} \\ 1 & {e}^{j ( 3 ) \frac{π}{8}} & {e}^{j ( 2 ) ( 3 ) \frac{π}{8}} & {e}^{j ( 3 ) ( 3 ) \frac{π}{8}}\end{matrix} ] , \\ n = 0 , 1 , 2 , 3$$

$${W}_{1}^{( n )} = [ \begin{matrix}{X}^{( n )} & 0 \\ 0 & {X}^{( n )}\end{matrix} ] , {CB}_{1} = \{ {W}_{1}^{( 0 )} , {W}_{1}^{( 1 )} , {W}_{1}^{( 2 )} , {W}_{1}^{( 3 )} \}$$

$${W}_{2} ∈ {CB}_{2} = \{ \frac{1}{\sqrt{2}} [ \begin{matrix}Y \\ Y\end{matrix} ] , \frac{1}{\sqrt{2}} [ \begin{matrix}Y \\ j Y\end{matrix} ] , \frac{1}{\sqrt{2}} [ \begin{matrix}Y \\ - Y\end{matrix} ] , \frac{1}{\sqrt{2}} [ \begin{matrix}Y \\ - j Y\end{matrix} ] \}$$

$$Y ∈ \{ [ \begin{matrix}1 \\ 0 \\ 0 \\ 0\end{matrix} ] , [ \begin{matrix}0 \\ 1 \\ 0 \\ 0\end{matrix} ] , [ \begin{matrix}0 \\ 0 \\ 1 \\ 0\end{matrix} ] , [ \begin{matrix}0 \\ 0 \\ 0 \\ 1\end{matrix} ] \}$$

Rank-2: CB₁ size-4, CB₂ size-8 where CB₂ the same as rank-1

$${W}_{2} ∈ {CB}_{2} = \{ \frac{1}{\sqrt{2}} [ \begin{matrix}Y & Y \\ Y & - Y\end{matrix} ] , \frac{1}{\sqrt{2}} [ \begin{matrix}Y & Y \\ j Y & - j Y\end{matrix} ] \}$$

$$Y ∈ \{ [ \begin{matrix}1 \\ 0 \\ 0 \\ 0\end{matrix} ] , [ \begin{matrix}0 \\ 1 \\ 0 \\ 0\end{matrix} ] , [ \begin{matrix}0 \\ 0 \\ 1 \\ 0\end{matrix} ] , [ \begin{matrix}0 \\ 0 \\ 0 \\ 1\end{matrix} ] \}$$

Rank-3: CB₁ size-2, CB₂ size-16

$${X}^{( n )} = \frac{1}{2} \times [ \begin{matrix}1 & 0 & 0 & 0 \\ 0 & {( - 1 )}^{n} & 0 & 0 \\ 0 & 0 & 1 & 0 \\ 0 & 0 & 0 & {( - 1 )}^{n}\end{matrix} ] [ \begin{matrix}1 & 1 & 1 & … & 1 \\ 1 & {e}^{j \frac{π}{8}} & {e}^{j ( 2 ) \frac{π}{8}} & … & {e}^{j ( 7 ) \frac{π}{8}} \\ 1 & {e}^{j ( 2 ) \frac{π}{8}} & {e}^{j ( 2 ) ( 2 ) \frac{π}{8}} & … & {e}^{j ( 7 ) ( 2 ) \frac{π}{8}} \\ 1 & {e}^{j ( 3 ) \frac{π}{8}} & {e}^{j ( 2 ) ( 3 ) \frac{π}{8}} & … & {e}^{j ( 7 ) ( 3 ) \frac{π}{8}}\end{matrix} ] , \\ n = 0 , 1$$

$${W}_{1}^{( n )} = [ \begin{matrix}{X}^{( n )} & 0 \\ 0 & {X}^{( n )}\end{matrix} ] , {CB}_{1} = \{ {W}_{1}^{( 0 )} , {W}_{1}^{( 1 )} \}$$

Here, X is a 4×8 matrix t 4 times oversampled 4 Tx DFT with level-2 partitioning.

$${W}_{2} ∈ {CB}_{2} = \{ \frac{1}{\sqrt{2}} [ \begin{matrix}{Y}_{1} & {Y}_{2} \\ {Y}_{1} & - {Y}_{2}\end{matrix} ] , \frac{1}{\sqrt{2}} [ \begin{matrix}{Y}_{1} & {Y}_{2} \\ j {Y}_{1} & - j {Y}_{2}\end{matrix} ] \}$$

$$( {Y}_{1} , {Y}_{2} ) ∈ \{ \begin{matrix}( {e}_{1} , [ \begin{matrix}{e}_{1} & {e}_{5}\end{matrix} ] ) , ( {e}_{2} , [ \begin{matrix}{e}_{2} & {e}_{6}\end{matrix} ] ) , ( {e}_{3} , [ \begin{matrix}{e}_{3} & {e}_{7}\end{matrix} ] ) , ( {e}_{4} , [ \begin{matrix}{e}_{4} & {e}_{8}\end{matrix} ] ) , \\ ( {e}_{5} , [ \begin{matrix}{e}_{1} & {e}_{5}\end{matrix} ] ) , ( {e}_{6} , [ \begin{matrix}{e}_{2} & {e}_{6}\end{matrix} ] ) , ( {e}_{7} , [ \begin{matrix}{e}_{3} & {e}_{7}\end{matrix} ] ) , ( {e}_{8} , [ \begin{matrix}{e}_{4} & {e}_{8}\end{matrix} ] )\end{matrix} \}$$

Rank-4: CB₂ size-2, CB₂ size-8 where CB₂ is the same as rank-3

$${W}_{2} ∈ {CB}_{2} = \{ \frac{1}{\sqrt{2}} [ \begin{matrix}Y & Y \\ Y & - Y\end{matrix} ] , \frac{1}{\sqrt{2}} [ \begin{matrix}Y & Y \\ j Y & - j Y\end{matrix} ] \}$$

$$Y ∈ \{ [ \begin{matrix}{e}_{1} & {e}_{5}\end{matrix} ] , [ \begin{matrix}{e}_{2} & {e}_{6}\end{matrix} ] , [ \begin{matrix}{e}_{3} & {e}_{7}\end{matrix} ] , [ \begin{matrix}{e}_{4} & {e}_{8}\end{matrix} ] \}$$

### Example 2B

### Variation of Example 3, Larger Rank-2 Codebook Size

Rank-1: CB₂ size-4, CB₂ size-16

$${X}^{( n )} = \frac{1}{2} \times [ \begin{matrix}1 & 0 & 0 & 0 \\ 0 & {( j )}^{n} & 0 & 0 \\ 0 & 0 & 1 & 0 \\ 0 & 0 & 0 & {( - j )}^{n}\end{matrix} ] [ \begin{matrix}1 & 1 & 1 & 1 \\ 1 & {e}^{j \frac{π}{8}} & {e}^{j ( 2 ) \frac{π}{8}} & {e}^{j ( 3 ) \frac{π}{8}} \\ 1 & {e}^{j ( 2 ) \frac{π}{8}} & {e}^{j ( 2 ) ( 2 ) \frac{π}{8}} & {e}^{j ( 3 ) ( 2 ) \frac{π}{8}} \\ 1 & {e}^{j ( 3 ) \frac{π}{8}} & {e}^{j ( 2 ) ( 3 ) \frac{π}{8}} & {e}^{j ( 3 ) ( 3 ) \frac{π}{8}}\end{matrix} ] , \\ n = 0 , 1 , 2 , 3$$

$${W}_{1}^{( n )} = [ \begin{matrix}{X}^{( n )} & 0 \\ 0 & {X}^{( n )}\end{matrix} ] , \\ {CB}_{1} = \{ {W}_{1}^{( 0 )} , {W}_{1}^{( 1 )} , {W}_{1}^{( 2 )} , {W}_{1}^{( 3 )} \}$$

$${W}_{2} ∈ {CB}_{2} = \{ \frac{1}{\sqrt{2}} [ \begin{matrix}Y \\ Y\end{matrix} ] , \frac{1}{\sqrt{2}} [ \begin{matrix}Y \\ j Y\end{matrix} ] , \frac{1}{\sqrt{2}} [ \begin{matrix}Y \\ - Y\end{matrix} ] , \frac{1}{\sqrt{2}} [ \begin{matrix}Y \\ - j Y\end{matrix} ] \}$$

$$Y ∈ \{ [ \begin{matrix}1 \\ 0 \\ 0 \\ 0\end{matrix} ] , [ \begin{matrix}0 \\ 1 \\ 0 \\ 0\end{matrix} ] , [ \begin{matrix}0 \\ 0 \\ 1 \\ 0\end{matrix} ] , [ \begin{matrix}0 \\ 0 \\ 0 \\ 1\end{matrix} ] \}$$

Rank-2: CB₁ size-4, CB₂ size-16

$${X}^{( n )} = \frac{1}{2} \times [ \begin{matrix}1 & 0 & 0 & 0 \\ 0 & {( - 1 )}^{n} & 0 & 0 \\ 0 & 0 & 1 & 0 \\ 0 & 0 & 0 & {( - 1 )}^{n}\end{matrix} ] [ \begin{matrix}1 & 1 & 1 & … & 1 \\ 1 & {e}^{j \frac{π}{8}} & {e}^{j ( 2 ) \frac{π}{8}} & … & {e}^{j ( 7 ) \frac{π}{8}} \\ 1 & {e}^{j ( 2 ) \frac{π}{8}} & {e}^{j ( 2 ) ( 2 ) \frac{π}{8}} & … & {e}^{j ( 7 ) ( 2 ) \frac{π}{8}} \\ 1 & {e}^{j ( 3 ) \frac{π}{8}} & {e}^{j ( 2 ) ( 3 ) \frac{π}{8}} & … & {e}^{j ( 7 ) ( 3 ) \frac{π}{8}}\end{matrix} ] , \\ n = 0 , 1$$

$${W}_{1}^{( n )} = [ \begin{matrix}{X}^{( n )} & 0 \\ 0 & {X}^{( n )}\end{matrix} ] , \\ {CB}_{1} = \{ {W}_{1}^{( 0 )} , {W}_{1}^{( 1 )} \}$$

$${W}_{2} ∈ {CB}_{2} = \{ \frac{1}{\sqrt{2}} [ \begin{matrix}Y & Y \\ Y & - Y\end{matrix} ] , \frac{1}{\sqrt{2}} [ \begin{matrix}Y & Y \\ j Y & - j Y\end{matrix} ] \}$$

$$Y ∈ \{ {e}_{1} , {e}_{2} , {e}_{3} , {e}_{4} , {e}_{5} , {e}_{6} , {e}_{7} , {e}_{8} \}$$

Rank-3: CB₁ size-2, CB₂ size-16 where CB₁ is the same as rank-2

$${W}_{2} ∈ {CB}_{2} = \{ \frac{1}{\sqrt{2}} [ \begin{matrix}{Y}_{1} & {Y}_{2} \\ {Y}_{1} & - {Y}_{2}\end{matrix} ] , \frac{1}{\sqrt{2}} [ \begin{matrix}{Y}_{1} & {Y}_{2} \\ j {Y}_{1} & - j {Y}_{2}\end{matrix} ] \}$$

$$( {Y}_{1} , {Y}_{2} ) ∈ \{ \begin{matrix}( {e}_{1} , [ \begin{matrix}{e}_{1} & {e}_{5}\end{matrix} ] ) , ( {e}_{2} , [ \begin{matrix}{e}_{2} & {e}_{6}\end{matrix} ] ) , ( {e}_{3} , [ \begin{matrix}{e}_{3} & {e}_{7}\end{matrix} ] ) , ( {e}_{4} , [ \begin{matrix}{e}_{4} & {e}_{8}\end{matrix} ] ) , \\ ( {e}_{5} , [ \begin{matrix}{e}_{1} & {e}_{5}\end{matrix} ] ) , ( {e}_{6} , [ \begin{matrix}{e}_{2} & {e}_{6}\end{matrix} ] ) , ( {e}_{7} , [ \begin{matrix}{e}_{3} & {e}_{7}\end{matrix} ] ) , ( {e}_{8} , [ \begin{matrix}{e}_{4} & {e}_{8}\end{matrix} ] )\end{matrix} \}$$

Rank-4: CB₂ size-2, CB₂ size-8 where CB₂ is the same as rank-2

$${W}_{2} ∈ {CB}_{2} = \{ \frac{1}{\sqrt{2}} [ \begin{matrix}Y & Y \\ Y & - Y\end{matrix} ] , \frac{1}{\sqrt{2}} [ \begin{matrix}Y & Y \\ j Y & - j Y\end{matrix} ] \}$$

$$Y ∈ \{ [ \begin{matrix}{e}_{1} & {e}_{5}\end{matrix} ] , [ \begin{matrix}{e}_{2} & {e}_{6}\end{matrix} ] , [ \begin{matrix}{e}_{3} & {e}_{7}\end{matrix} ] , [ \begin{matrix}{e}_{4} & {e}_{8}\end{matrix} ] \}$$

### Example 3A

### W₁ is a Tall Matrix, Same W₁ for All Ranks

$${X}^{( n )} = \frac{1}{2} \times [ \begin{matrix}1 & 0 & 0 & 0 \\ 0 & {e}^{j \frac{π n}{4}} & 0 & 0 \\ 0 & 0 & {( j )}^{n} & 0 \\ 0 & 0 & 0 & {e}^{j \frac{3 π n}{4}}\end{matrix} ] [ \begin{matrix}1 & 1 \\ 1 & {e}^{j \frac{π}{8}} \\ 1 & {e}^{j ( 2 ) \frac{π}{8}} \\ 1 & {e}^{j ( 3 ) \frac{π}{8}}\end{matrix} ] , \\ n = 0 , 1 , 2 , 3 , 4 , 5 , 6 , 7$$

$${CB}_{1} size \text{-} 8$$

$${W}_{1}^{( n )} = [ \begin{matrix}{X}^{( n )} & 0 \\ 0 & {X}^{( n )}\end{matrix} ] , \\ {CB}_{1} = \{ {W}_{1}^{( 0 )} , {W}_{1}^{( 1 )} , {W}_{1}^{( 2 )} , … , {W}_{1}^{( 7 )} \}$$

Here, X comes from a 4 times oversampled 4 Tx DFT matrix with level-8 partitioning.
Rank-1: CB₂ size-8

$${W}_{2} ∈ {CB}_{2} = \{ \frac{1}{\sqrt{2}} [ \begin{matrix}Y \\ Y\end{matrix} ] , \frac{1}{\sqrt{2}} [ \begin{matrix}Y \\ j Y\end{matrix} ] , \frac{1}{\sqrt{2}} [ \begin{matrix}Y \\ - Y\end{matrix} ] , \frac{1}{\sqrt{2}} [ \begin{matrix}Y \\ - j Y\end{matrix} ] \}$$

$$Y ∈ \{ [ \begin{matrix}1 \\ 0\end{matrix} ] , [ \begin{matrix}0 \\ 1\end{matrix} ] \}$$

Rank-2: CB₂ size-8

$${W}_{2} ∈ {CB}_{2} = \{ \frac{1}{\sqrt{2}} [ \begin{matrix}Y & Y \\ {e}^{j \frac{π}{4} k} Y & - {e}^{j \frac{π}{4} k} Y\end{matrix} ] , k = 0 , 1 , 2 , 3 \}$$

$$Y ∈ \{ [ \begin{matrix}1 \\ 0\end{matrix} ] , [ \begin{matrix}0 \\ 1\end{matrix} ] \}$$

Rank-3: CB₂ size-8

$${W}_{2} ∈ {CB}_{2} = \{ \frac{1}{\sqrt{2}} [ \begin{matrix}{Y}_{1} & {Y}_{2} \\ {e}^{j \frac{π}{4} k} {Y}_{1} & - {e}^{j \frac{π}{4} k} {Y}_{2}\end{matrix} ] , k = 0 , 1 , 2 , 3 \}$$

$$( {Y}_{1} , {Y}_{2} ) ∈ \{ ( [ \begin{matrix}1 \\ 0\end{matrix} ] , [ \begin{matrix}1 & 0 \\ 0 & 1\end{matrix} ] ) , ( [ \begin{matrix}0 \\ 1\end{matrix} ] , [ \begin{matrix}1 & 0 \\ 0 & 1\end{matrix} ] ) \}$$

Rank-4: CB₂ size-4

$${W}_{2} ∈ {CB}_{2} = \{ \frac{1}{\sqrt{2}} [ \begin{matrix}Y & Y \\ {e}^{j \frac{π}{4} k} Y & - {e}^{j \frac{π}{4} k} Y\end{matrix} ] , k = 0 , 1 , 2 , 3 \}$$

$$Y = [ \begin{matrix}1 & 0 \\ 0 & 1\end{matrix} ]$$

### Example 3B

### Similar to Example 3A, Smaller Higher Ranks Codebooks

$${X}^{( n )} = \frac{1}{2} \times [ \begin{matrix}1 & 0 & 0 & 0 \\ 0 & {e}^{j \frac{π n}{4}} & 0 & 0 \\ 0 & 0 & {( j )}^{n} & 0 \\ 0 & 0 & 0 & {e}^{j \frac{3 π n}{4}}\end{matrix} ] [ \begin{matrix}1 & 1 \\ 1 & {e}^{j \frac{π}{8}} \\ 1 & {e}^{j ( 2 ) \frac{π}{8}} \\ 1 & {e}^{j ( 3 ) \frac{π}{8}}\end{matrix} ] , \\ n = 0 , 1 , 2 , 3 , 4 , 5 , 6 , 7$$

$${CB}_{1} size \text{-} 8$$

$${W}_{1}^{( n )} = [ \begin{matrix}{X}^{( n )} & 0 \\ 0 & {X}^{( n )}\end{matrix} ] , \\ {CB}_{1} = \{ {W}_{1}^{( 0 )} , {W}_{1}^{( 1 )} , {W}_{1}^{( 2 )} , … , {W}_{1}^{( 7 )} \}$$

Rank-1: CB₂ size-8

$${W}_{2} ∈ {CB}_{2} = \{ \frac{1}{\sqrt{2}} [ \begin{matrix}Y \\ Y\end{matrix} ] , \frac{1}{\sqrt{2}} [ \begin{matrix}Y \\ j Y\end{matrix} ] , \frac{1}{\sqrt{2}} [ \begin{matrix}Y \\ - Y\end{matrix} ] , \frac{1}{\sqrt{2}} [ \begin{matrix}Y \\ - j Y\end{matrix} ] \}$$

$$Y ∈ \{ [ \begin{matrix}1 \\ 0\end{matrix} ] , [ \begin{matrix}0 \\ 1\end{matrix} ] \}$$

Rank-2: CB₂ size-4

$${W}_{2} ∈ {CB}_{2} = \{ \frac{1}{\sqrt{2}} [ \begin{matrix}Y & Y \\ Y & - Y\end{matrix} ] , \frac{1}{\sqrt{2}} [ \begin{matrix}Y & Y \\ j Y & - j Y\end{matrix} ] \}$$

$$Y ∈ \{ [ \begin{matrix}1 \\ 0\end{matrix} ] , [ \begin{matrix}0 \\ 1\end{matrix} ] \}$$

Rank-3: CB₂ size-4

$${W}_{2} ∈ {CB}_{2} = \{ \frac{1}{\sqrt{2}} [ \begin{matrix}{Y}_{1} & {Y}_{2} \\ {Y}_{1} & - {Y}_{2}\end{matrix} ] , \frac{1}{\sqrt{2}} [ \begin{matrix}{Y}_{1} & {Y}_{2} \\ j {Y}_{1} & - j {Y}_{2}\end{matrix} ] \}$$

$$( {Y}_{1} , {Y}_{2} ) ∈ \{ ( [ \begin{matrix}1 \\ 0\end{matrix} ] , [ \begin{matrix}1 & 0 \\ 0 & 1\end{matrix} ] ) , ( [ \begin{matrix}0 \\ 1\end{matrix} ] , [ \begin{matrix}1 & 0 \\ 0 & 1\end{matrix} ] ) \}$$

Rank-4: CB₂ size-2

$${W}_{2} ∈ {CB}_{2} = \{ \frac{1}{\sqrt{2}} [ \begin{matrix}Y & Y \\ Y & - Y\end{matrix} ] , \frac{1}{\sqrt{2}} [ \begin{matrix}Y & Y \\ j Y & - j Y\end{matrix} ] \}$$

$$Y = [ \begin{matrix}1 & 0 \\ 0 & 1\end{matrix} ]$$

This invention is a codebook design consisting of two different sets is given: the first set targets the ULA configuration while the second set is designed based on the properties of dual-polarized antenna setup. The design requires 2 bits for PMI₁ (long-term, wideband) and 4 bits for PMI₂ (short-term, sub-band). The PUCCH payload is kept the same as Rel-8/9 as PMI₁ is either reported together with RI or separately reported in different sub-frames from RI and CQI/PMI.

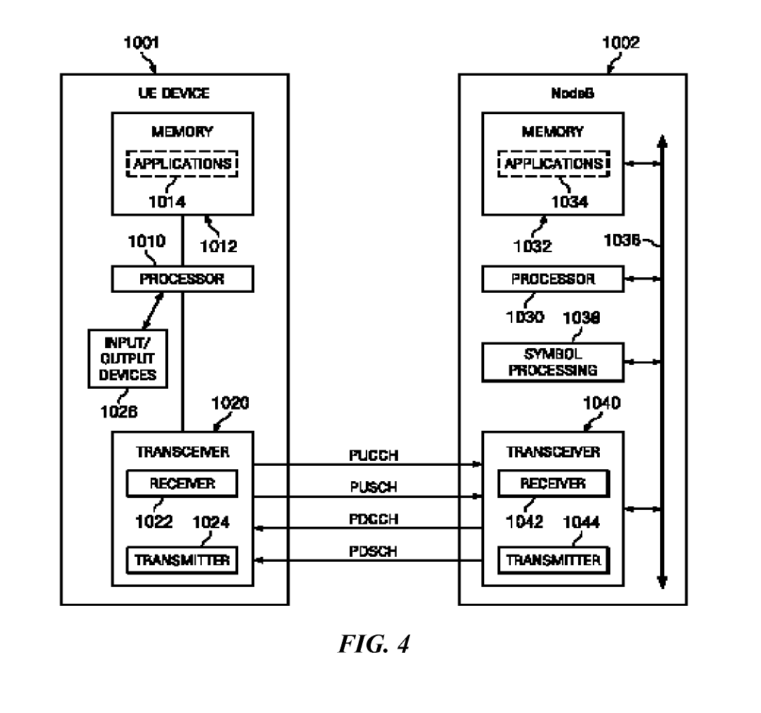

FIG. 4 is a block diagram illustrating internal details of an eNB 1002 and a mobile UE 1001 in the network system of FIG. 1. Mobile UE 1001 may represent any of a variety of devices such as a server, a desktop computer, a laptop computer, a cellular phone, a Personal Digital Assistant (PDA), a smart phone or other electronic devices. In some embodiments, the electronic mobile UE 1001 communicates with eNB 1002 based on a LTE or Evolved Universal Terrestrial Radio Access Network (E-UTRAN) protocol. Alternatively, another communication protocol now known or later developed can be used.

Mobile UE 1001 comprises a processor 1010 coupled to a memory 1012 and a transceiver 1020. The memory 1012 stores (software) applications 1014 for execution by the processor 1010. The applications could comprise any known or future application useful for individuals or organizations. These applications could be categorized as operating systems (OS), device drivers, databases, multimedia tools, presentation tools, Internet browsers, emailers, Voice-Over-Internet Protocol (VoIP) tools, file browsers, firewalls, instant messaging, finance tools, games, word processors or other categories. Regardless of the exact nature of the applications, at least some of the applications may direct the mobile UE 1001 to transmit UL signals to eNB (base-station) 1002 periodically or continuously via the transceiver 1020. In at least some embodiments, the mobile UE 1001 identifies a Quality of Service (QoS) requirement when requesting an uplink resource from eNB 1002. In some cases, the QoS requirement may be implicitly derived by eNB 1002 from the type of traffic supported by the mobile UE 1001. As an example, VoIP and gaming applications often involve low-latency uplink (UL) transmissions while High Throughput (HTP)/Hypertext Transmission Protocol (HTTP) traffic can involve high-latency uplink transmissions.

Transceiver 1020 includes uplink logic which may be implemented by execution of instructions that control the operation of the transceiver. Some of these instructions may be stored in memory 1012 and executed when needed by processor 1010. As would be understood by one of skill in the art, the components of the uplink logic may involve the physical (PHY) layer and/or the Media Access Control (MAC) layer of the transceiver 1020. Transceiver 1020 includes one or more receivers 1022 and one or more transmitters 1024.

Processor 1010 may send or receive data to various input/output devices 1026. A subscriber identity module (SIM) card stores and retrieves information used for making calls via the cellular system. A Bluetooth baseband unit may be provided for wireless connection to a microphone and headset for sending and receiving voice data. Processor 1010 may send information to a display unit for interaction with a user of mobile UE 1001 during a call process. The display may also display pictures received from the network, from a local camera, or from other sources such as a Universal Serial Bus (USB) connector. Processor 1010 may also send a video stream to the display that is received from various sources such as the cellular network via RF transceiver 1020 or the camera.

During transmission and reception of voice data or other application data, transmitter 1024 may be or become non-synchronized with its serving eNB. In this case, it sends a random access signal. As part of this procedure, it determines a preferred size for the next data transmission, referred to as a message, by using a power threshold value provided by the serving eNB, as described in more detail above. In this embodiment, the message preferred size determination is embodied by executing instructions stored in memory 1012 by processor 1010. In other embodiments, the message size determination may be embodied by a separate processor/memory unit, by a hardwired state machine, or by other types of control logic, for example.

eNB 1002 comprises a Processor 1030 coupled to a memory 1032, symbol processing circuitry 1038, and a transceiver 1040 via backplane bus 1036. The memory stores applications 1034 for execution by processor 1030. The applications could comprise any known or future application useful for managing wireless communications. At least some of the applications 1034 may direct eNB 1002 to manage transmissions to or from mobile UE 1001.

Transceiver 1040 comprises an uplink Resource Manager, which enables eNB 1002 to selectively allocate uplink Physical Uplink Shared CHannel (PUSCH) resources to mobile UE 1001. As would be understood by one of skill in the art, the components of the uplink resource manager may involve the physical (PHY) layer and/or the Media Access Control (MAC) layer of the transceiver 1040. Transceiver 1040 includes at least one receiver 1042 for receiving transmissions from various UEs within range of eNB 1002 and at least one transmitter 1044 for transmitting data and control information to the various UEs within range of eNB 1002.

The uplink resource manager executes instructions that control the operation of transceiver 1040. Some of these instructions may be located in memory 1032 and executed when needed on processor 1030. The resource manager controls the transmission resources allocated to each UE 1001 served by eNB 1002 and broadcasts control information via the PDCCH.

Symbol processing circuitry 1038 performs demodulation using known techniques. Random access signals are demodulated in symbol processing circuitry 1038.

During transmission and reception of voice data or other application data, receiver 1042 may receive a random access signal from a UE 1001. The random access signal is encoded to request a message size that is preferred by UE 1001. UE 1001 determines the preferred message size by using a message threshold provided by eNB 1002. In this embodiment, the message threshold calculation is embodied by executing instructions stored in memory 1032 by processor 1030. In other embodiments, the threshold calculation may be embodied by a separate processor/memory unit, by a hardwired state machine, or by other types of control logic, for example. Alternatively, in some networks the message threshold is a fixed value that may be stored in memory 1032, for example. In response to receiving the message size request, eNB 1002 schedules an appropriate set of resources and notifies UE 1001 with a resource grant.

What is claimed is:

1. A method of wireless telephony between at least one fixed base station and at least one mobile user equipment comprising the steps of:
defining a default mode of one of said at least one user equipment transmitting to a corresponding fixed base station via a single-antenna port;
defining a multi-antenna-port mode of one of said at least one user equipment transmitting to a corresponding fixed base station via a multi-antenna port;
transmitting a mode identifying signal from a fixed base station to one of said at least one user equipment specifying said default mode or said multi-antenna-port mode; and
said one of said at least one user equipment transmitting to said corresponding fixed base station via a mode specified by said fixed base station on a Physical Uplink Shared CHannel.

2. The method of claim 1, wherein:
said step of transmitting a mode identifying signal uses Radio Resource Control (RRC) signaling.

3. The method of claim 2, wherein:
said step of transmitting a mode identifying signal employs a 5-bit MCS-RV and 1-bit NDI for the second codeword (CW1) are needed for the DCI format 4.

4. The method of claim 3, wherein:
said step of transmitting a mode identifying signal employs a precoding information field represents joint encoding of transmit rank indicator (TRI) and transmit precoding matrix indicator (TPMI).

5. The method of claim 4, wherein:
said joint encoding of TRI and TPMI has 3 bits for two transmitter ports.

6. The method of claim 4, wherein:
said joint encoding of TRI and TPMI has 6 bits for four transmitter ports.

7. The method of claim 4, wherein:
said joint encoding of TRI and TPMI has a 1-bit TB-to-CW swap flag.

8. The method of claim 1, wherein:
said step of transmitting a mode identifying signal employs a selected number of one or two transport blocks (TBs).

9. The method of claim 8, wherein:
a TB may be enabled or disabled.

10. The method of claim 8, wherein:
said step of transmitting a mode identifying signal enables or disables a selected TB when a transmit rank indicator (TRI) is 1 via a state of a TB-to-CW swap flag.

11. The method of claim 8, wherein:
said step of transmitting a mode identifying signal cannot enable or disable a TB when a transmit rank indicator (TRI) is greater than 1.
